(19) United States
(12) Patent Application Publication
(10) Pub. No.: US 2006/0003114 A1
(43) Pub. Date: Jan. 5, 2006

(54) Multilayer film

(76) Inventors: Howard Enlow, Munster, IN (US); Keith L. Truong, Crown Point, IN (US); Norman A. Conti, Painesville, OH (US)

Correspondence Address: RENNER, OTTO, BOISSELLE & SKLAP, LLP, 1621 EUCLID AVE, 19TH FL, CLEVELAND, OH, 44115-2191, US

(21) Appl. No.: 11/198,661

(22) Filed: Aug. 5, 2005

Related U.S. Application Data
(62) Division of application No. 10/457,827, filed on Jun. 9, 2003.

(51) Int. Cl. B41M 5/00

(52) U.S. Cl. 428/32.24

(57) ABSTRACT

This disclosed invention relates to a multilayer film, comprising: a first transparent film layer having an upper surface and a lower surface; a second transparent film layer overlying the upper surface of the first transparent film layer; an ink layer, ink receptive layer or metalized layer overlying and adhered to a surface of the first transparent layer or the second transparent layer; and a first adhesive layer overlying the lower surface of the first transparent film layer. These multilayer films are useful as decals.

### RELATED APPLICATIONS

This application is a divisional of, and claims priority under 35 U.S.C. § 120 to, copending and commonly-assigned U.S. application Ser. No. 10/457,827 which was filed on Jun. 9, 2003. The entire disclosure of this earlier application is hereby incorporated by reference.

### TECHNICAL FIELD

This invention relates to multilayer films. These multilayer films are useful as decals.

### BACKGROUND OF THE INVENTION

A decal is a picture, design or label made to be transferred to a substrate such as glass from a carrier such as a release liner. A problem with many of the decals in the art relates to the fact that the edges remain visible after the decal is transferred to the substrate. The visibility of these edges detracts from the appearance of the decal and the design or information presented by the decal. This invention provides a solution to this problem

### SUMMARY OF THE INVENTION

This invention relates to a multilayer film, comprising: a first transparent film layer having an upper surface and a lower surface; a second transparent film layer overlying the upper surface of the first transparent film layer; an ink layer, ink receptive layer or metalized layer overlying and adhered to a surface of the first transparent layer or a surface of the second transparent layer; and a first adhesive layer overlying the lower surface of the first transparent film layer. In one embodiment, the ink layer is positioned between the first transparent film layer and the second transparent film layer. In one embodiment, the ink receptive layer is positioned between the first transparent film layer and the second transparent film layer. In one embodiment, the ink receptive layer overlies the upper surface of the first transparent film layer. In one embodiment, the ink receptive layer overlies the lower surface of the first transparent film layer. In one embodiment, the metalized layer overlies the lower surface of the first transparent film layer. These multilayer films may be used as decals. An advantage of the decals provided by this invention relates to the fact that, at least in one embodiment, the edges substantially disappear and are therefore not noticeable when the decal is applied to a substrate.

### BRIEF DESCRIPTION OF THE DRAWINGS

In the annexed drawings, like references indicate like parts or features.

FIG. 1 is a schematic illustration of the side view of a multilayer film embodying the present invention in a particular form.

FIG. 2 is a schematic illustration of the side view of another embodiment of the multilayer film of the present invention.

FIG. 3 is a schematic illustration of the side view of still another embodiment of the multilayer film of the present invention.

FIG. 4 is a schematic illustration of the side view of still another embodiment of the multilayer film of the present invention.

FIG. 5 is a schematic illustration of the side view of still another embodiment of the multilayer film of the present invention.

FIG. 6 is a schematic illustration of the side view of still another embodiment of the multilayer film of the present invention.

FIG. 7 is a schematic illustration of the side view of still another embodiment of the multilayer film of the present invention.

FIG. 8 is a schematic illustration of the side view of still another embodiment of the multilayer film of the present invention.

FIG. 9 is a schematic illustration of the multilayer film illustrated in FIG. 3, the multilayer film being partially wound into a roll.

FIG. 10 is a schematic illustration of the side view of still another embodiment of the multilayer film of the present invention.

FIG. 11 is a schematic illustration of the side view of still another embodiment of the multilayer film of the present invention.

FIG. 12 is a schematic illustration of the side view of still another embodiment of the multilayer film of the present invention.

FIG. 13 is a schematic illustration of the side view of still another embodiment of the multilayer film of the present invention.

FIG. 14 is a schematic illustration of the side view of still another embodiment of the multilayer film of the present invention.

FIG. 15 is a schematic illustration of the side view of still another embodiment of the multilayer film of the present invention.

FIG. 16 is a schematic illustration of the side view of still another embodiment of the multilayer film of the present invention.

FIG. 17 is a schematic illustration of the side view of still another embodiment of the multilayer film of the present invention.

### DESCRIPTION OF THE PREFERRED EMBODIMENTS

The terms “over” and “overlies” and cognate terms such as “overlying” and the like, when referring to the relationship of one or a first layer relative to another or a second layer, refers to the fact that the first layer partially or completely lies over the second layer. The first layer overlying the second layer may or may not be in contact with the second layer. For example, one or more additional layers may be positioned between the first layer and the second layer. The terms “under” and “underlies” and cognate terms such as “underlying” and the like have similar meanings except that the first layer partially or completely lies under, rather than over, the second layer.

The term “between” when referring to the position of a first layer relative to the position of a second layer and a third layer, refers to the fact that the second layer and third layer are on opposite sides of the first layer. The first layer may or may not be in contact with the second layer or the third layer. For example, one or more additional layers may be positioned between the first layer and the second layer or between the first layer and the third layer.

The term “transparent” when referring to a transparent film layer overlying a layer of the inventive multilayer film means that the underlying layer can be seen through the transparent film layer. The transparent film layer may be translucent.

The terms “upper” and “lower” are sometimes used in the specification and the appended claims to refer to the relative position of a layer or a surface of a layer used in the inventive multilayer film. These terms refer to relative positions as illustrated in the drawings. For example, in the drawings, the first transparent film layer 110 has an upper surface 112 and a lower surface 114. While it is recognized that the multilayer films illustrated in the drawings could be tilted sideways or upside down and as such an upper or lower layer or surface would not technically be an “upper” or “lower”,layer or surface, it is to be understood that in determining whether a multilayer film has an upper or lower layer or surface, the multilayer film is to be oriented as illustrated in the drawings.

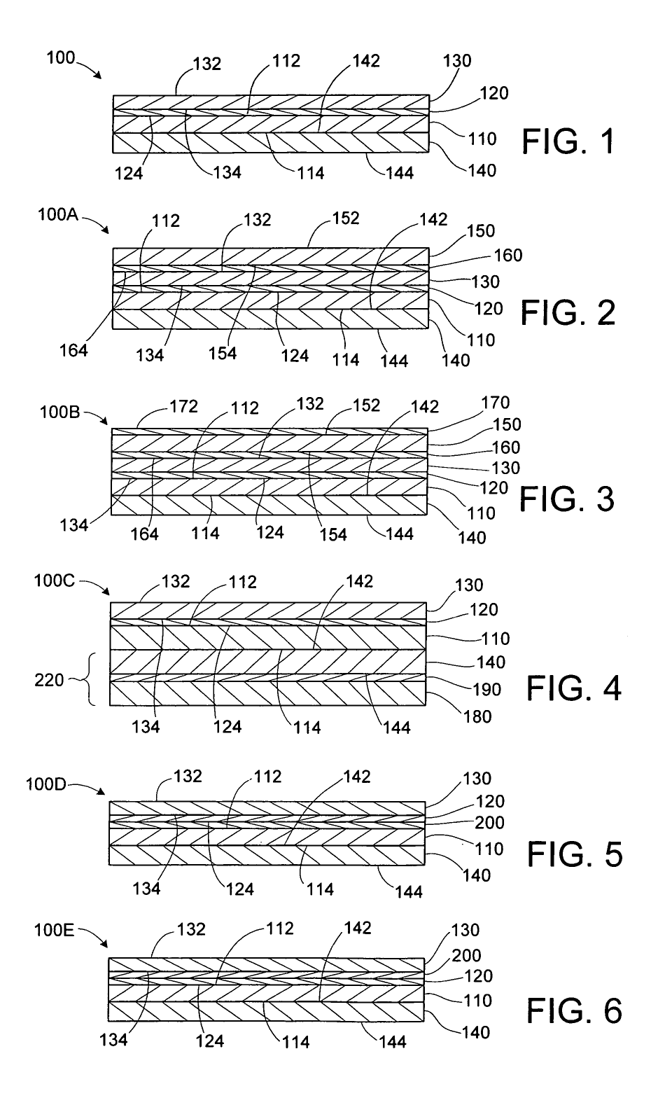

Referring to FIG. 1, the inventive multilayer film, in one of its illustrated embodiments, is indicated generally by the reference numeral 100, and comprises: a first transparent film layer 110 having an upper surface 112 and a lower surface 114; an ink layer 120 overlying the upper surface 112 of the first transparent film layer 110; a second transparent film layer 130 overlying the ink layer 120, the second transparent film layer having an upper surface 132 and a lower surface 134; and a first adhesive layer 140 overlying the lower surface 114 of the first transparent film layer 110, the first adhesive layer 140 having an upper surface 142 and a lower surface 144.

The multilayer film 100A illustrated in FIG. 2 is identical to the multilayer film 100 illustrated in FIG. 1, except that the multilayer film 100A further comprises: a first release liner 150 overlying the upper surface 132 of the second transparent film layer 130, the first release liner 150 having an upper surface 152 and a lower surface 154; and a first release coating layer 160 positioned between the lower surface 154 of the first release liner 150 and the upper surface 132 of the second transparent film layer 130. The first release coating layer 160 preferentially adheres to first release liner 150. Thus when the first release liner 150 is separated from the second transparent film layer 130, the first release coating layer 160 separates from the second transparent film layer 130 and remains adhered to the first release liner 150.

The multilayer film 100B illustrated in FIG. 3 is identical to the multilayer film 100A illustrated in FIG. 2, except that the multilayer film 100B further comprises: a third release coating layer 170 overlying the upper surface 152 of the first release liner 150. In this embodiment, the first adhesive layer 140 comprises a pressure sensitive adhesive.

Referring to FIG. 9, the multilayer film 100B is wound into roll form with the upper surface 172 of third release coating layer 170 in contact with the lower surface 144 of first adhesive layer 140. The third release coating layer 170 preferentially adheres to first release liner 150. Thus, when the multilayer film 100B illustrated in FIG. 9 is unwound, the third release coating layer 170 separates from the first adhesive layer 140 and remains adhered to first release liner 150.

The multilayer film 100C illustrated in FIG. 4 is identical to the multilayer film 100 illustrated in FIG. 1, except that the multilayer film 100C further comprises: a second release liner 180 overlying the adhesive layer 140; and a second release coating layer 190 positioned between the second release liner 180 and the first adhesive layer 140. In this embodiment, the first adhesive layer 140 comprises a pressure sensitive adhesive layer. The second release coating layer 190 preferentially adheres to second release liner 180. Thus when the second release liner 180 is separated from the first adhesive layer 140, the second release coating layer 190 separates from the first adhesive layer 140 and remains adhered to the second release liner 180.

The multilayer film 100D illustrated in FIG. 5 is identical to the multilayer film 100 illustrated in FIG. 1, except that the multilayer film 100D further comprises: an ink receptive layer 200 positioned between the first transparent film layer 110 and the ink layer 120.

The multilayer film 100E illustrated in FIG. 6 is identical to the multilayer film 100 illustrated in FIG. 1, except that the multilayer film 100E further comprises: an ink receptive layer 200 positioned between the second transparent film layer 130 and the ink layer 120.

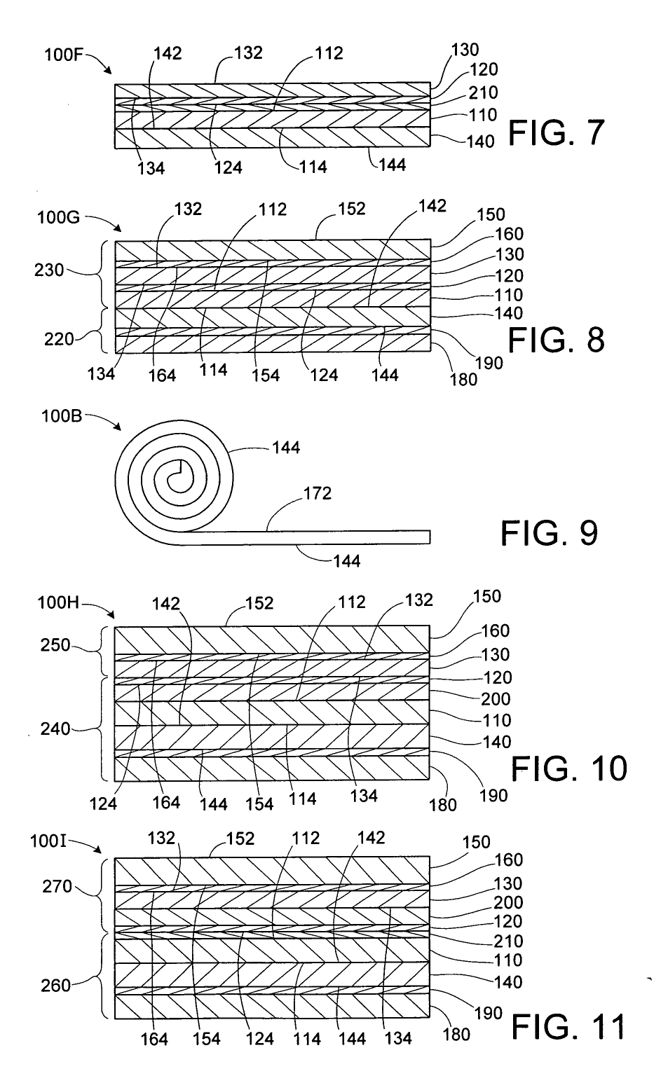

The multilayer film 100F illustrated in FIG. 7 is identical to the multilayer film 100 illustrated in FIG. 1, except that the multilayer film 100F further comprises: a heat activated adhesive layer 210 positioned between the first transparent film layer 110 and the ink layer 120.

The multilayer film 100G illustrated in FIG. 8 is identical to the multilayer film 100C illustrated in FIG. 4, except that the multilayer film 100G further comprises: first release liner 150 overlying the second transparent film layer 130, the first release liner 150 having an upper surface 152 and a lower surface 154; and a first release coating layer 160 positioned between the first release liner 150 and the second transparent film layer 130. The first release coating layer 160 preferentially adheres to first release liner 150. Thus when the first release liner 150 is separated from the second transparent film layer 130, the first release coating layer 160 separates from the second transparent film layer 130 and remains adhered to the first release liner 150.

The multilayer film 100H illustrated in FIG. 10 is identical to the multilayer film 100G illustrated in FIG. 8, except that the multilayer film 100H further comprises: an ink receptive layer 200 positioned between the first transparent film layer 110 and the ink layer 120.

The multilayer film 1001 illustrated in FIG. 11 is identical to the multilayer film 100G illustrated in FIG. 8, except that the multilayer film 1001 further comprises: an ink receptive layer 200 positioned between the second transparent film layer 130 and the ink layer 120; and a heat activated adhesive layer 210 positioned between the first transparent film layer 110 and the ink layer 120.

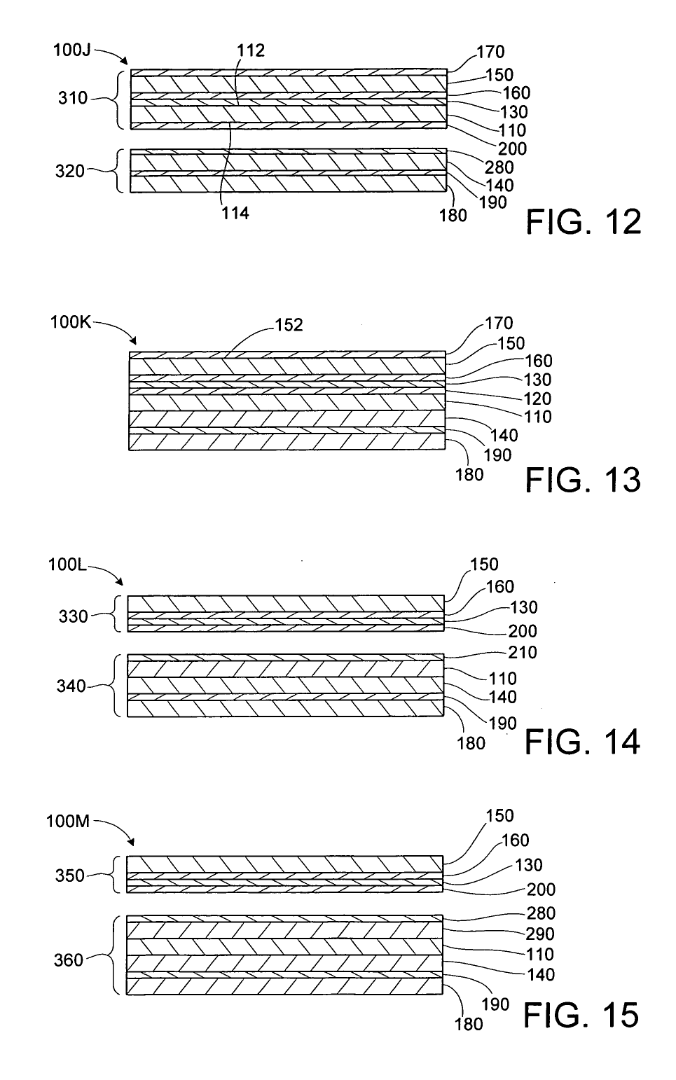

The multilayer film 100J illustrated in FIG. 12 may be made from partial film constructions 310 and 320. Partial film construction 310 comprises: first transparent film layer 110 having an upper surface 112 and a lower surface 114; an ink receptive layer 200 overlying the lower surface 114 of first transparent film layer 110; second transparent film layer 130 overlying the upper surface 112 of first transparent film layer 110; first release coating layer 160 overlying second transparent film layer 130; first release liner 150 overlying first release coating layer 160; and third release coating layer 170 overlying first release liner 150. Partial film construction 320 comprises: second release liner 180; second release coating layer 190 overlying one side of second release liner 180; first adhesive layer 140 overlying second release coating layer 190; and third release liner 280 overlying first adhesive layer 140. Third release liner 280 has a release coating layer on one of its sides, this release coating layer being positioned between the third release liner 280 and first adhesive layer 140. Partial film constructions 310 and 320 may be shipped to a customer or user, and the customer or user may apply an ink layer 120 using, for example, an ink jet, laser or digital printer, to the surface of the ink receptive layer 200. After application of the ink layer 120, release liner 280 may be removed from partial film construction 320, and then partial film construction 320 may be adhered to partial film construction 310 with adhesive layer 140 being adhered to the ink layer 120 overlying the ink receptive layer 200.

The multilayer film 100K illustrated in FIG. 13 is identical to the multilayer film 100G illustrated in FIG. 8 with the exception that the multilayer film 100K includes third release coating layer 170 overlying first release liner 150.

The multilayer film 100L illustrated in FIG. 14 may be made from partial film constructions 330 and 340. Partial film construction 330 comprises: ink receptive layer 200; second transparent film layer 130 overlying ink receptive layer 200; first release coating layer 160 overlying second transparent film layer 130; and first release liner 150 overlying first release coating layer 160. Partial film construction 340 comprises: second release liner 180; second release coating layer 190 overlying second release coating liner 180; first adhesive layer 140 overlying second release coating layer 190; first transparent film layer 110 overlying first adhesive layer 140; and heat activatable adhesive layer 210 overlying first transparent film layer 110. The partial film constructions 330 and 340 may be shipped to a customer or user who may apply an ink layer 120 using, for example, an ink jet, laser or digital printer, to the surface of the ink receptive layer 200. The partial film constructions 330 and 340 may then be adhered to each other with the heat activatable adhesive layer 110 in contact with the ink layer 120 overlying the ink receptive layer 200. Heat and optionally pressure may be applied to activate the heat activatable adhesive layer 210 and thereby adhere the partial film constructions 330 and 340 together.

The multilayer film 100M illustrated in FIG. 15 may be made using partial film constructions 350 and 360. Partial film construction 350 comprises: ink receptive layer 200; second transparent film layer 130 overlying ink receptive layer 200; first release coating layer 160 overlying second transparent film layer 130; and first release liner 150 overlying first release coating layer 160. Partial film construction 360 comprises: second release liner 180; second release coating layer 190 overlying one side of the second release liner 180; first adhesive layer 140 overlying second release coating layer 190; first transparent film layer 110 overlying first adhesive layer 140; second adhesive layer 290 overlying first transparent film layer 110; and third release liner 280 overlying second adhesive layer 290. The user may apply an ink layer 120 to the ink receptive layer 200 using, for example, an ink jet, laser or digital printer. The multilayer film 100M may then be assembled by removing third release liner 280 from partial film construction 360 and then adhering second adhesive layer 290 to the ink layer 120 overlying ink receptive layer 200.

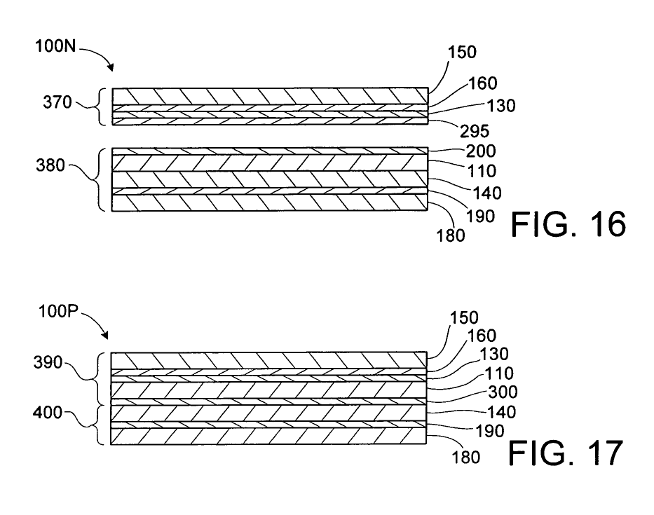

Multilayer film 100N illustrated in FIG. 16 may be made using partial film constructions 370 and 380. Partial film construction 370 comprises: third adhesive layer 295; second transparent film layer 130 overlying third adhesive layer 295; first release coating layer 160 overlying second transparent film layer 130; and first release liner 150 overlying first release coating layer 160. Partial film construction 380 comprises: second release liner 180; second release coating layer 190 overlying one of the side of second release liner 180; first adhesive layer 140 overlying second release coating layer 190; first transparent film layer 110 overlying first adhesive layer 140; and ink receptive layer 200 overlying first transparent film layer 110. The user may apply an ink layer 120 to the ink receptive layer 220 using, for example, an ink jet, laser or digital printer, and then assemble the multilayer film 100N by adhering partial film construction 370 to partial film construction 380 with third adhesive layer 295 contacting the ink layer 120 overlying the ink receptive layer 200.

The multilayer film 100P illustrated in FIG. 17 comprises: second release liner 180; second release coating layer 190 overlying one side of second release liner 180; first adhesive layer 140 overlying second release coating layer 190; metalized layer 300 overlying first adhesive layer 140; first transparent film layer 110 overlying metalized layer 300; second transparent film layer 130 overlying first transparent film layer 110; first release coating layer 160 overlying second transparent film layer 130; and first release liner 150 overlying first release coating layer 160. In one embodiment, an ink layer 120 may be positioned between the first transparent film layer 110 and the second transparent film layer 130.

The first transparent film layer 110 may have a thickness of about 0.1 to about 0.9 mil, and in one embodiment about 0.2 to about 0.4 mils, and in one embodiment about 0.7 to about 0.9 mil. The thickness of the ink layer 120 may range from about 0.02 to about 0.15 mil, and in one embodiment about 0.02 to about 0.10 mil, and in one embodiment about 0.02 to about 0.08 mil. The thickness of the second transparent film layer 130 may range from about 0.1 to about 0.9 mil, and in one embodiment about 0.7 to about 0.9 mil, and in one embodiment about 0.2 to about 0.4 mil. The thickness of the first adhesive layer 140 may range from about 0.4 to about 1 mil, and in one embodiment about 0.4 to about 0.8 mil. The thickness of the first release liner 150 may range from about 0.5 to about 2 mil, and in one embodiment about 0.5 to about 1.5 mil, and in one embodiment about 0.8 to about 1.1 mil. The thickness of the first release coating layer 160 may range from about 0.05 to about 0.3 mil, and in one embodiment about 0.1 to about 0.2 mil, and in one embodiment about 0.15 mil. The thickness of the third release coating layer 170 may range from about 0.02 to about 0.2 mil, and in one embodiment about 0.04 to about 0.08 mil. The thickness of the second release liner 180 may range from about 0.5 to about 3 mil, and in one embodiment about 0.5 to about 1.5 mil. The thickness of the second release coating layer 190 may range from about 0.02 to about 0.2 mil, and in one embodiment about 0.04 to about 0.08 mil. The thickness of the ink receptive layer 200 may range from about 0.05 to about 0.2 mil, and in one embodiment about 0.05 to about 0.15 mil, and in one embodiment about 0.10 to about 0.15 mil. The thickness of the heat activated adhesive layer 210 may range from about 0.05 to about 0.15 mil, and in one embodiment about 0.08 to about 0.12 mil. The thickness of the third release liner 280 may range from about 0.5 to about 3 mil, and in one embodiment about 0.5 to about 1.5 mil. The thickness of the second adhesive layer 290 may range from about 0.4 to about 1 mil, and in one embodiment about 0.4 to about 0.8 mil. The thickness of the third adhesive layer 295 may range from about 0.4 to about 1 mil, and in one embodiment about 0.4 to about 0.8 mil. The thickness of the metalized layer 300 may range from about 100 to about 500 angstroms, and in one embodiment about 200 to about 300 angstroms. In one embodiment, the thickness of the metalized layer 300 is measured in terms of optical density (O.D.) and has a thickness of about 0.05 to about 2.5 O.D., and in one embodiment about 1.0 to about 2.5 O.D. Each of the foregoing thicknesses are dry film thicknesses. The multilayer films 100 through 100P may have any width and length that is suitable for facilitated use by the end user. For example, the width may range from about 1 to about 200 cm, and in one embodiment about 10 to about 100 cm, and in one embodiment about 30 to about 40 cm. The length may range from about 10 to about 6500 meters, and in one embodiment about 10 to about 3000 meters, and in one embodiment about 15 to about 1000 meters. These multilayer films may be provided in roll form as illustrated in FIG. 9. The multilayer films may be provided in the form of flat sheets having any width and length, for example 1 by 1 inch (2.54 by 2.54 cm), 2 by 2 inches (5.08 by 5.08 cm), 36 by 36 inches (0.91 by 0.91 meters), etc.

The transparent film layers 110 and 130 may each comprise independently one or more resins. These layers may be made from liquid coating compositions comprising the one or more resins, water or one or more solvents, and optionally one or more additional additives for controlling properties such as rheological properties and the like. These layers may independently be made from one or more hot melt film forming compositions and may comprise one or more extruded or die coated film layers.

The resin used in making the film layers 110 and 130 may comprise any resin conventionally used in coating or paint formulations. The resin may comprise a thermoplastic or a thermosetting resin. The resin may comprise a synthetic resin or a natural resin. Examples of useful resins include acrylic resins, vinyl resins, polyester resins, alkyd resins, butadiene resins, styrene resins, phthalic acid or anhydride resins, urethane resins, epoxy resins, and the like. The resin may comprise vinyl or vinylidene polymers or copolymers containing units such as vinyl acetate, vinyl chloride, vinylidene chloride, and the like; hydrocarbon polymers and copolymers containing ethylene or proplene units and oxygenated or halogenated derivatives of ether, butadiene, oxygenated butadiene, isoprene, oxygenated isoprene, butadiene-styrene, butadiene vinyl toluene, isoprene-styrene and the like; polymers or copolymers containing units of acrylic acid, methacrylic acid, their esters, or acrylonitrile; vinylic hydrocarbon monomers reacted with unsaturated materials such as the reaction product of maleic acid or anhydride with styrene; and, broadly, various other resinous rubber-like elastomeric latex polymers and copolymers of ethylenically unsaturated monomers and polymers obtainable in stable aqueous latex form. The resin may comprise a copolymer of vinyl chloride and vinyl acetate. The resin may comprise polyvinyl chloride or a copolymer of vinyl chloride or acrylic and methacrylic acid. The resin may comprise diphenylmethane diisocyanate, methylene diethyl diisocyanate, isocyanurate, urea-formaldehyde, phenolformaldehyde, phenolic glue, animal hide glues, and the like. The resin may comprise a fluorine resin, silicone resins, or fibrin resin.

The resin may comprise one or more polystyrenes, polyolefins, polyamides, polyesters, polycarbonates, polyvinyl alcohol, polyethylene vinyl alcohol, polyurethanes, polyacrylates, polyvinyl acetates, ionomers and mixtures thereof.

The polyolefins may be characterized as having a melt index or melt flow rate of less than about 30, and in one embodiment less than about 20, and in one embodiment less than about 10 as determined by ASTM Test Method 1238. The polyolefins include polymers and copolymers of ethylene, propylene, 1-butene, etc., or blends of mixtures of such polymers and copolymers. The polyolefins may comprise polymers and copolymers of ethylene and propylene. The polyolefins may comprise propylene homopolymers, and copolymers such as propylene-ethylene and propylene-1-butene copolymers. Blends of polypropylene and polyethylene with each other, or blends of either or both of them with a polypropylene-polyethylene copolymer may be used. The polyolefin film forming materials may have a high propylenic content, either polypropylene homopolymer or propylene-ethylene copolymers or blends of polypropylene and polyethylene with low ethylene content, or propylene-1-butene copolymers or blend of polypropylene and poly-1-butene with low butene content.

Various polyethylenes may be used including low, medium, and high density polyethylenes. The low density range for the polyethylenes may be from about 0.910 to about 0.925 g/cm³, the medium density range may be from about 0.925 to about 0.940 g/cm³, and the high density range may be from about 0.940 to about 0.965 g/cm³. An example of a useful low density polyethylene (LDPE) is Rexene 1017 available from Huntsman.

The propylene homopolymers which may be used either alone or in combination with a propylene copolymer include a variety of propylene homopolymers such as those having melt flow rates (MFR) from about 0.5 to about 20 as determined by ASTM Test D 1238, condition L. In one embodiment, propylene homopolymers having MFR's of less than about 10, and in one embodiment from about 4 to about 10 may be used. The propylene homopolymers may be characterized as having densities in the range of from about 0.88 to about 0.92 g/cm³. A number of useful propylene homopolymers are available commercially from a variety of sources, and some useful polymers include: 5A97, available from Union Carbide and having a melt flow of 12.0g/10 min and a density of 0.90 g/cm³; DX5E66, also available from Union Carbide and having an MFI of 8.8 g/10 min and a density of 0.90 g/cm³; and WRD5-1057 from Union Carbide having an MFI of 3.9 g/10 min and a density of 0.90 g/cm³. Useful commercial propylene homopolymers are also available from Fina and Montel.

The polyamide resins include resins available from EMS American Grilon Inc., Sumter, S.C. under the general tradename Grivory such as CF6S, CR-9, XE3303 and G-21. Grivory G-21 is an amorphous nylon copolymer having a glass transition temperature of 125° C., a melt flow index (DIN 53735) of 90 ml/10 min and an elongation at break (ASTM D638) of 15. Grivory CF65 is a nylon 6/12 film grade resin having a melting point of 135° C., a melt flow index of 50 ml/10 min, and an elongation at break in excess of 350%. Grilon CR9 is another nylon 6/12 film grade resin having a melting point of 200° C., a melt flow index of 200 ml/10 min, and an elongation at break at 250%. Grilon XE 3303 is a nylon 6.6/6.10 film grade resin having a melting point of 200° C., a melt flow index of 60 ml/10 min, and an elongation at break of 100%. The polyamide resins include those available from, for example, Union Camp of Wayne, N.J. under the Uni-Rez product line, and dimer-based polyamide resins available from Bostik, Emery, Fuller, Henkel (under the Versamid product line). The polyamides include those produced by condensing dimerized vegetable acids with hexamethylene diamine. Examples of polyamides available from Union Camp include Uni-Rez 2665; Uni-Rez 2620; Uni-Rez 2623; and Uni-Rez 2695.

The polystyrenes include homopolymers as well as copolymers of styrene and substituted styrene such as alpha-methyl styrene. Examples of styrene copolymers and terpolymers include: acrylonitrile-butene-styrene (ABS); styrene-acrylonitrile copolymers (SAN); styrene butadiene (SB); styrene-maleic anhydride (SMA); and styrene-methyl methacrylate (SMMA); etc.

The polyurethanes include aliphatic as well as aromatic polyurethanes.

The polyesters may be prepared from various glycols or polyols and one or more aliphatic or aromatic carboxylic acids. Polyethylene terephthalate (PET) and PETG (PET modified with cyclohexanedimethanol) are useful film forming materials which are available from a variety of commercial sources including Eastman. For example, Kodar 6763 is a PETG available from Eastman Chemical. Another useful polyester from DuPont is Selar PT-8307 which is polyethylene terephthalate.

Acrylate polymers and copolymers and alkylene vinyl acetate resins (e.g., EVA polymers) may be used. Examples include Escorene UL-7520 (Exxon), a copolymer of ethylene with 19.3% vinyl acetate; Nucrell 699 (DuPont), an ethylene copolymer containing 11% of methacrylic acid, etc.

Ionomers (polyolefins containing ionic bonding of molecular chains) may be used. Examples of ionomers include ionomeric ethylene copolymers such as Surlyn 1706 (DuPont) which is believed to contain interchain ionic bonds based on a zinc salt of ethylene methacrylic acid copolymer. Surlyn 1702 from DuPont is an ionomer that may be used.

Polycarbonates also are useful, and these are available from the Dow Chemical Co. (Calibre) G. E. Plastics (Lexan) and Bayer (Makrolon). These polycarbonates may be obtained by the reaction of bisphenol A and carbonyl chloride in an interfacial process. Molecular weights may vary from about 22,000 to about 35,000, and the melt flow rates may be in the range of from about 4 to about 22 g/10 min.

The solvent may comprise an organic solvent, such as a ketone, ester, aliphatic compound, aromatic compound, alcohol, glycol, glycol ether, etc. These include methylethyl ketone, methylisobutyl ketone, ethyl acetate, white spirits, alkanes, cycloalkanes, benzene, hydrocarbon substituted aromatic compounds (e.g., toluene, the xylenes, etc.), isoparaffinic solvents, and combinations of two or more thereof. Alternatively, water or a water-based solution may be used to form an emulsion with the resin. The water-based solutions include water-alcohol mixtures, and the like. The water or solvent is sufficiently volatile so that when applied to a substrate, the water or solvent evaporates leaving behind the resin and any other additional non-volatile ingredients.

Additional ingredients that may be used include wetting agents; plasticizers; suspension aids; thixotropic agents such as silica; water repellant additives such as polysiloxane compounds; fire retardant additives; biocides; defoamers; flow agents; and the like.

The transparent film layers 110 and 130 may each be derived from a single coat or multiple coats of the film material. When multiple coats are used, each coat may have the same or a different formulation. Each of these film layers may provide enhanced scuff resistance, stain resistance and/or recoatability.

The following coating compositions may be used to make either or both of the transparent film layers 110 and 130:

| | Percent |
|---|---|
| | by Weight |
| Transparent Coating Composition No. 1 | |
| Methyl ethyl ketone | 38.18 |
| Toluene | 19.06 |
| VYHH (product of Dow Chemical identified | 28.85 |
| as a vinyl chloride/vinyl acetate copolymer) | |
| Edinol 9790 (a product of Cognis identified | 14.11 |
| as a polyester plasticizer) | |
| | 100.00 |
| Transparent Coating Composition No. 2 | |
| Methyl ethyl ketone | 40.94 |
| Toluene | 26.97 |
| Vitel 2200B (a product of Bostik Findley | 16.04 |
| identified as a linear saturated polyester | |
| resin having an Mn = 24,500) | |
| Vitel 2650 (a product of Bostik Findley | 16.04 |
| identified as a polyester copolymer) | |
| | 100.00 |

The ink layer 120 may be a mono-colored or multi-colored ink layer, depending on the printed message and/or pictorial design intended for the inventive multilayer film. These include variable imprinted data such as serial numbers, bar codes, and the like. The ink layer 120 may comprise one or more layers of ink. The ink used in the ink layer 120 may be a water-based, solvent-based or radiation-curable (e.g., UV curable) ink. Examples include 345-36500 (Naphthol red from Gibraltar Chemical), 345-34130 (phthalo blue from Gibraltar), and 345-39420 (carbon black from Gibraltar). The ink layer may be applied using an ink jet printer, laser printer, digital printer, thermal printer, and the like. An example of an ink jet printer that may be used is a Sol Jet Pro II digitally controlled ink jet printer supplied by Roland DG Corporation.

The first adhesive layer 140 may comprise any pressure sensitive, moisture activatable or heat activatable adhesive known in the art for use with film substrates. The second adhesive layer 290 may be a pressure sensitive adhesive. The third adhesive layer 295 may be a pressure sensitive adhesive layer or a heat activatable adhesive layer. These adhesive layers may each be in the form of a continuous or discontinuous layer, and may each comprise one or a mixture of two or more adhesives. Each adhesive layer may be in the form of a patterned adhesive layer with a relatively strong adhesive in some areas and a relatively weak adhesive in other areas. In one embodiment, the adhesive layer 140 provides initial tack and allows slight movement of the multilayer film to allow positioning adjustments prior to forming a permanent bond. In one embodiment, the adhesive layer 140 permits facilitated stripping of the multilayer film from a substrate when use of the multilayer film or the substrate is no longer desired. In one embodiment, the adhesive layers are characterized by producing only a limited amount of ooze beyond the borders of the multilayer film when the multilayer film is applied to a substrate. In one embodiment, no ooze is produced. The adhesive layers may comprise a rubber based adhesive, acrylic adhesive, vinyl ether adhesive, silicone adhesive, or mixture of two or more thereof. The adhesive layers may be applied as a hot melt, solvent-based or water based adhesive. Included are adhesive materials described in “Adhesion and Bond”, Encyclopedia of Polymer Science and Engineering, Vol. 1, pages 476-546, Interscience Publishers, 2^{nd} Ed. 1985, the disclosure of which is hereby incorporated by reference. The adhesive materials that are useful may contain as a major constituent an adhesive polymer such as an acrylic-type polymer; block copolymer; natural, reclaimed, or styrene-butadiene rubber; tackified natural or synthetic rubber; a copolymer of ethylene and vinyl acetate; an ethylene-vinyl-acrylic terpolymer; polyisobutylene; poly (vinyl ether); etc. Other materials may be included in the adhesive such as tackifying resins, plasticizers, antioxidants, fillers, waxes, etc.

The adhesives may be classified into the following categories: random copolymer adhesives such as those based upon acrylate and/or methacrylate copolymers, α-olefin copolymers, silicone copolymers, chloroprene/acrylonitrile copolymers, and the like; block copolymer adhesives including those based upon linear block copolymers (i.e., A-B and A-B-A type), branched block copolymers, star block copolymers, grafted or radial block copolymers, and the like; and natural and synthetic rubber adhesives. A description of useful pressure-sensitive adhesives may be found in Encyclopedia of Polymer Science and Engineering, Vol. 13. Wiley-lnterscience Publishers (New York, 1988). Additional description of useful pressure-sensitive adhesives may be found in Encyclopedia of Polymer Science and Technology, Vol. 1, Interscience Publishers (New York, 1964).

Pressure-sensitive adhesives that may be used include the hot melt pressure-sensitive adhesives available from H. B. Fuller Company, St. Paul, Minn. as HM-1597, HL-2207-X, HL-2115-X, HL-2193-X. Other useful pressure-sensitive adhesives include those available from Century Adhesives Corporation, Columbus, Ohio.

Conventional PSAs, including silicone-based PSAs, rubber-based PSAs, and acrylic-based PSAs are useful. Another commercial example of a hot melt adhesive is H2187-01, sold by Ato Findley, Inc., of Wauwatusa, Wis. In addition, rubber based block copolymer PSAs described in U.S. Pat. No. 3,239,478 (Harlan) also can be used, and this patent is hereby incorporated by a reference for its disclosure of such hot melt adhesives.

In one embodiment, the pressure sensitive adhesives comprise rubber based elastomer materials such as linear, branched, graft or radial block copolymers represented by the diblock structures A-B, the triblock A-B-A, the radial or coupled structures (A-B)ₙ, and combinations of these where A represents a hard thermoplastic phase or block which is non-rubbery or glassy or crystalline at room temperature but fluid at higher temperatures, and B represents a soft block which is rubbery or elastomeric at service or room temperature. These thermoplastic elastomers may comprise from about 75% to about 95% by weight of rubbery segments and from about 5% to about 25% by weight of non-rubbery segments.

The non-rubbery segments or hard blocks comprise polymers of mono- and polycyclic aromatic hydrocarbons, and more particularly vinyl-substituted aromatic hydrocarbons which may be monocyclic or bicyclic in nature. The rubbery blocks or segments are typically polymer blocks of homopolymers or copolymers of aliphatic conjugated dienes. Rubbery materials such as polyisoprene, polybutadiene, and styrene butadiene rubbers may be used to form the rubbery block or segment. The rubbery segments include polydienes and saturated olefin rubbers of ethylene/butylene or ethylene/propylene copolymers. The latter rubbers may be obtained from the corresponding unsaturated polyalkylene moieties such as polybutadiene and polyisoprene by hydrogenation thereof.

The block copolymers of vinyl aromatic hydrocarbons and conjugated dienes which may be utilized include any of those which exhibit elastomeric properties. The block copolymers may be diblock, triblock, multiblock, starblock, polyblock or graftblock copolymers. Throughout this specification and claims, the terms diblock, triblock, multiblock, polyblock, and graft or grafted-block with respect to the structural features of block copolymers are to be given their normal meaning as defined in the literature such as in the Encyclopedia of Polymer Science and Engineering, Vol. 2, (1985) John Wiley & Sons, Inc., New York, pp. 325-326, and by J. E. McGrath in Block Copolymers, Science Technology, Dale J. Meier, Ed., Harwood Academic Publishers, 1979, at pages 1-5.

Such block copolymers may contain various ratios of conjugated dienes to vinyl aromatic hydrocarbons including those containing up to about 40% by weight of vinyl aromatic hydrocarbon. Accordingly, multi-block copolymers may be utilized which are linear or radial symmetric or asymmetric and which have structures represented by the formulae A-B, A-B-A, A-B-A-B, B-A-B, (AB)_{0,1,2} . . . BA, etc., wherein A is a polymer block of a vinyl aromatic hydrocarbon or a conjugated diene/vinyl aromatic hydrocarbon tapered copolymer block, and B is a rubbery polymer block of a conjugated diene.

The block copolymers may be prepared by any of the well-known block polymerization or copolymerization procedures including sequential addition of monomer, incremental addition of monomer, or coupling techniques as illustrated in, for example, U.S. Pat. Nos. 3,251,905; 3,390,207; 3,598,887; and 4,219,627. As is well known, tapered copolymer blocks can be incorporated in the multi-block copolymers by copolymerizing a mixture of conjugated diene and vinyl aromatic hydrocarbon monomers utilizing the difference in their copolymerization reactivity rates. Various patents describe the preparation of multi-block copolymers containing tapered copolymer blocks including U.S. Pat. Nos. 3,251,905; 3,639,521; and 4,208,356, the disclosures of which are hereby incorporated by reference.

Conjugated dienes which may be utilized to prepare the polymers and copolymers are those containing from 4 to about 10 carbon atoms and more generally, from 4 to 6 carbon atoms. Examples include from 1,3-butadiene, 2-methyl-1,3-butadiene (isoprene), 2,3-dimethyl-1,3-butadiene, chloroprene, 1,3-pentadiene, 1,3-hexadiene, etc. Mixtures of these conjugated dienes also may be used. The preferred conjugated dienes are isoprene and 1,3-butadiene.

Examples of vinyl aromatic hydrocarbons which may be utilized to prepare the copolymers include styrene and the various substituted styrenes such as o-methylstyrene, p-methylstyrene, p-tert-butylstyrene, 1,3-dimethylstyrene, alpha-methylstyrene, beta-methylstyrene, p-isopropylstyrene, 2,3-dimethylstyrene, o-chlorostyrene, p-chlorostyrene, o-bromostyrene, 2-chloro-4-methylstyrene, etc. The preferred vinyl aromatic hydrocarbon is styrene.

Many of the above-described copolymers of conjugated dienes and vinyl aromatic compounds are commercially available. The number average molecular weight of the block copolymers, prior to hydrogenation, is from about 20,000 to about 500,000, preferably from about 40,000 to about 300,000.

The average molecular weights of the individual blocks within the copolymers may vary within certain limits. In most instances, the vinyl aromatic block will have a number average molecular weight in the order of about 2000 to about 125,000, and preferably between about 4000 and 60,000. The conjugated diene blocks either before or after hydrogenation will have number average molecular weights in the order of about 10,000 to about 450,000 and more preferably from about 35,000 to 150,000.

Also, prior to hydrogenation, the vinyl content of the conjugated diene portion generally is from about 10% to about 80%, and the vinyl content is preferably from about 25% to about 65%, particularly 35% to 55% when it is desired that the modified block copolymer exhibit rubbery elasticity. The vinyl content of the block copolymer can be measured by means of nuclear magnetic resonance.

Specific examples of diblock copolymers include styrene-butadiene (SB), styrene-isoprene (SI), and the hydrogenated derivatives thereof. Examples of triblock polymers include styrene-butadiene-styrene (SBS), styrene-isoprene-styrene (SIS), alpha-methylstyrene-butadiene-alpha-methylstyrene, and alpha-methylstyrene-isoprene alpha-methylstyrene. Examples of commercially available block copolymers useful as the adhesives in the present invention include those available from Shell Chemical Company and listed in the following Table II.

TABLE II

| | | Styrene/Rubber | Melt |
|---|---|---|---|
| Kraton | Type | Ratio (w) | Index |
| D1101 | Linear SBS | 31/69 | <1 |
| D1107P | Linear SIS | 15/85 | 11 |
| D1111 | Linear SIS | 22/78 | 3 |
| D1112P | Linear SIS | 15/85 | 23 |
| D1113P | Linear SIS | 16/84 | 24 |
| D1117P | Linear SIS | 17/83 | 33 |
| D1320X | Multi-arm (SI)ₙ | 10/90 | NA |

Vector 4111 is an SIS block copolymer available from Dexco of Houston Tex.

Upon hydrogenation of the SBS copolymers comprising a rubbery segment of a mixture of 1,4 and 1,2 isomers, a styrene-ethylene-butylene styrene (SEBS) block copolymer is obtained. Similarly, hydrogenation of an SIS polymer yields a styrene-ethylene propylene-styrene (SEPS) block copolymer.

The selective hydrogenation of the block copolymers may be carried out by a variety of well known processes including hydrogenation in the presence of such catalysts as Raney nickel, noble metals such as platinum, palladium, etc., and soluble transition metal catalysts. Suitable hydrogenation processes which can be used are those wherein the diene-containing polymer or copolymer is dissolved in an inert hydrocarbon diluent such as cyclohexane and hydrogenated by reaction with hydrogen in the presence of a soluble hydrogenation catalyst. Such procedures are described in U.S. Pat. Nos. 3,113,986 and 4,226,952, the disclosures of which are incorporated herein by reference. Such hydrogenation of the block copolymers which are carried out in a manner and to extent as to produce selectively hydrogenated copolymers having a residual unsaturation content in the polydiene block of from about 0.5% to about 20% of their original unsaturation content prior to hydrogenation.

In one embodiment, the conjugated diene portion of the block copolymer is at least 90% saturated and more often at least 95% saturated while the vinyl aromatic portion is not significantly hydrogenated. Useful hydrogenated block copolymers include hydrogenated products of the block copolymers of styrene-isoprene-styrene such as a styrene-(ethylene/propylene)-styrene block polymer. When a poly-styrene-polybutadiene-polystyrene block copolymer is hydrogenated, it is desirable that the 1,2-polybutadiene to 1,4-polybutadiene ratio in the polymer is from about 30:70 to about 70:30. When such a block copolymer is hydrogenated, the resulting product resembles a regular copolymer block of ethylene and 1-butene (EB). When the conjugated diene employed as isoprene, the resulting hydrogenated product resembles a regular copolymer block of ethylene and propylene (EP).

A number of selectively hydrogenated block copolymers are available commercially from Shell Chemical Company under the general trade designation “Kraton G.” One example is Kraton G1652 which is a hydrogenated SBS triblock comprising about 30% by weight of styrene end blocks and a midblock which is a copolymer of ethylene and 1-butene (EB). A lower molecular weight version of G1652 is available from Shell under the designation Kraton G1650. Kraton G1651 is another SEBS block copolymer which contains about 33% by weight of styrene. Kraton G1657 is an SEBS diblock copolymer which contains about 13%w styrene. This styrene content is lower than the styrene content in Kraton G1650 and Kraton G1652.

In another embodiment, the selectively hydrogenated block copolymer is of the formula
Bₙ(AB)ₒAₚ
wherein: n=0 or 1; o is 1 to 100; p is 0 or 1; each B prior to hydrogenation is predominantly a polymerized conjugated diene hydrocarbon block having a number average molecular weight of about 20,000 to about 450,000; and each A is predominantly a polymerized vinyl aromatic hydrocarbon block having a number average molecular weight of from about 2000 to about 115,000; the blocks of A constituting about 5% to about 95% by weight of the copolymer; and the unsaturation of the block B is less than about 10% of the original unsaturation. In other embodiments, the unsaturation of block B is reduced upon hydrogenation to less than 5% of its original value, and the average unsaturation of the hydrogenated block copolymer is reduced to less than 20% of its original value.

The block copolymers may also include functionalized polymers such as may be obtained by reacting an alpha, beta-olefinically unsaturated monocarboxylic or dicarboxylic acid reagent onto selectively hydrogenated block copolymers of vinyl aromatic hydrocarbons and conjugated dienes as described above. The reaction between the carboxylic acid reagent in the graft block copolymer can be effected in solutions or by a melt process in the presence of a free radical initiator.

The preparation of various selectively hydrogenated block copolymers of conjugated dienes and vinyl aromatic hydrocarbons which have been grafted with a carboxylic acid reagent is described in a number of patents including U.S. Pat. Nos. 4,578,429; 4,657,970; and 4,795,782, and the disclosures of these patents relating to grafted selectively hydrogenated block copolymers of conjugated dienes and vinyl aromatic compounds, and the preparation of such compounds are hereby incorporated by reference. U.S. Pat. No. 4,795,782 describes and gives examples of the preparation of the grafted block copolymers by the solution process and the melt process. U.S. Pat. No. 4,578,429 contains an example of grafting of Kraton G1652 (SEBS) polymer with maleic anhydride with 2,5-dimethyl-2,5-di(t-butylperoxy) hexane by a melt reaction in a twin screw extruder.

Examples of commercially available maleated selectively hydrogenated copolymers of styrene and butadiene include Kraton FG1901X, FG1921X, and FG1924X from Shell, often referred to as maleated selectively hydrogenated SEBS copolymers. FG1901X contains about 1.7% w bound functionality as succinic anhydride and about 28% w of styrene. FG1921X contains about 1% w of bound functionality as succinic anhydride and 29% w of styrene. FG1924X contains about 13% styrene and about 1% bound functionality as succinic anhydride.

Useful block copolymers also are available from Nippon Zeon Co., 2-1, Marunochi, Chiyoda-ku, Tokyo, Japan. For example, Quintac 3530 is available from Nippon Zeon and is believed to be a linear styrene-isoprene-styrene block copolymer.

The adhesive compositions may contain at least one solid tackifier resin component. A solid tackifier is defined herein as one having a softening point above 80° C. When the solid tackifier resin component is present, the adhesive compositions may comprise from about 40 to about 80% by weight of a thermoplastic elastomer component and from about 20% to about 60% by weight, and in one embodiment from about 55 to about 65% by weight of a solid tackifier resin component. The solid tackifier reduces the modulus of the mixture sufficiently to build tack or adhesion. Also, solid tackifiers (particularly the higher molecular weight solid tackifiers (e.g., Mw greater than about 2000) and those having a lower dispersity (Mw/Mn=less than about 3)) may be less sensitive to migration into the polymer film layer, and this is desirable, since migration of tackifier into the film layer 110 or 180 may cause dimensional instability.

The solid tackifier resins include hydrocarbon resins, rosin, hydrogenated rosin, rosin esters, polyterpene resins, and other resins which exhibit the proper balance of properties. A variety of useful solid tackifier resins are available commercially such as terpene resins which are sold under the trademark Zonatac by Arizona Chemical Company, and petroleum hydrocarbons resins such as the resins sold under the trademark Escorez by Exxon Chemical Company. One particular example of a useful solid tackifier is Escorez 2596 which is a C₅-C₉ (aromatic modified aliphatic) synthetic tackifier having an Mw of 2100 and a dispersity (Mw/Mn) of 2.69. Another useful solid tackifier is Escorez 1310LC, identified as an aliphatic hydrocarbon resin having an Mw of 1350 and a dispersity of 1.8. Wingtack 95 is a synthetic tackifier resin available from Goodyear, Akron, Ohio consisting predominantly of polymerized structure derived from piperylene and isoprene.

The modulus of the adhesive may be lowered by the incorporation of liquid rubbers, i.e., liquid at room temperature. The liquid rubbers generally will have an Mw of at least 5,000 and more often at least 20,000. Incorporation of liquid rubbers in amounts of less than 10%, and even less than 5% by weight based on the overall weight of the adhesive formulation results in adhesives which is coextrudable with the polymeric film materials. The incorporation of a liquid rubber may produce an adhesive having increased tack and adhesion. Liquid block copolymers such as liquid styrene-isoprene block copolymers may be used. Examples include Kraton LVSI -101, available from the Shell Chemical Company. Another example is a liquid polyisoprene obtained by depolymerization of high molecular weight polyisoprene. An example of a commercially available depolymerized high molecular weight polyisoprene is Isolene D-400 from Elementis Performance Polymers, Belleville, N.J., and this liquid rubber has an Mw of about 20,000. Other liquid rubbers which may be incorporated into the adhesive mixture include liquid styrene-butadiene rubbers, liquid butadiene rubbers, ethylene-propylene rubbers, etc.

The adhesive compositions also may include other materials such as antioxidants, heat and light stabilizers, ultraviolet light absorbers, antiblocking agents, processing aids, etc. Hindered phenolic and amine antioxidant compounds may be included in the adhesive compositions, and a wide variety of such antioxidant compounds are known in the art. A variety of antioxidants are available from Ciba-Geigy under the general trade designations “Irganox” and “Irgafos”. For example, the hindered phenolic antioxidant n-octadecyl 3-(3,5-di-t-butyl-4-hydroxyphenol)-proprionate is available under the general trade designation “Irganox 1076”. Irganox 1010, is identified as Tetrakis (methylene 3-(3′,5′-di-tert-butyl-4′-hydroxyphenol) proprionate) methane. Irgafos 168 is another useful antioxidant from Ciba-Geigy. Hydroquinone-based antioxidants also may be utilized, and one example of such an antioxidant is 2,5-di-tertiary-amyl-hydroquinone. Light stabilizers, heat stabilizers, and UV absorbers also may be included in the adhesive compositions. Ultraviolet absorbers include benzo-triazol derivatives, hydroxy benzyl phenones, esters of benzoic acids, oxalic acid, diamides, etc. Light stabilizers include hindered amine light stabilizers, and the heat stabilizers include dithiocarbamate compositions such as zinc dibutyl dithiocarbamate.

The release liners 150, 180 and 280 may each comprise independently paper, polymer film, or a combination thereof. Paper liners are useful because of the wide variety of applications in which they can be employed. Paper is also relatively inexpensive and has desirable properties such as antiblocking, antistatic, dimensional stability, and can potentially be recycled. Any type of paper having sufficient tensile strength to be handled in conventional paper coating and treating apparatus can be employed as the release liner. Thus, any type of paper can be used depending upon the end use and particular personal preferences. Included among the types of paper which can be used are clay coated paper, glassine, polymer coated paper, hemp, and similar cellulose materials prepared by such processes as the soda, sulfite or sulfate (Kraft) processes, the neutral sulfide cooking process, alkali-chlorine processes, nitric acid processes, semi-chemical processes, etc. Although paper of any weight may be employed as a release liner, paper having weights in the range of from about 30 to about 120 pounds per ream are useful, and papers having weights in the range of from about 60 to about 100 pounds per ream may be used. The term “ream” as used herein equals 3000 square feet.

Alternatively, the release liners 150, 180 and 280 may independently comprise a polymer film, and examples of polymer films include polyolefin, polyester, and combinations thereof. The polyolefin films may comprise polymer and copolymers of monoolefins having from 2 to about 12 carbon atoms, and in one embodiment from 2 to about 8 carbon atoms, and in one embodiment 2 to about 4 carbon atoms per molecule. Examples of such homopolymers include polyethylene, polypropylene, poly-1-butene, etc. Films prepared from blends of copolymers or blends of copolymers with homopolymers may be used. The films may be extruded in mono or multilayers.

Another type of material which may be used as the release liners 150, 180 and/or 280 is a polycoated kraft liner which is basically comprised of a kraft liner that is coated on either one or both sides with a polymer coating. The polymer coating, which may comprise a high, medium, or low density polyethylene, a propylene, polyester, or other similar polymer films, is coated onto the substrate surface to add strength and/or dimensional stability to the liner. The low density range for the polyethylene is from about 0.910 to about 0.925 g/cm³; the medium density range is from about 0.925 to about 0.940 g/cm³; and the high density range is from about 0.940 to about 0.965 g/cm³. The weight of these types of liners ranges from about 30 to about 100 pounds per ream, with about 94 to about 100 pounds per ream being useful. In total, the final release liner 150, 180 and/or 280 may comprise from about 10% to about 40% polymer and from about 60% to about 90% paper. For two sided coatings, the quantity of polymer may be approximately evenly divided between the top and bottom surface of the paper.

The first release coating layer 160 may be derived from a single coat of release coating material or multiple coats. When multiple coats are used, each coat may have the same formulation, or different formulations may be used. The first release coating layer 160 may comprise any of the resins disclosed above for use in the film layers 110 and/or 130 which provide sufficient tack or adherence between the first release coating layer 160, second transparent film layer 130 and first release liner 150 to prevent separation of the first release liner 150 from the second transparent film layer 130 during the making of the inventive multilayer film and normal handling of the multilayer film, and yet have sufficient release properties to provide for facilitated separation between the first release coating layer 160 and the second transparent film layer 130 when using the multilayer film. The first release coating layer 160 may comprise an alkyd resin and/or a vinyl resin cross linked with a melamine resin. The alkyd resins include resins formed by the condensation of one or more polyhydric alcohols with one or more polybasic acids or anhydrides. The polyhydric alcohols include glycerol and the polybasic acids or anhydrides include phthalic anhydride. Modified alkyds wherein the polybasic acid is substituted in part by a monobasic acid such as acrylic acid or a vegetable oil fatty acid may be used. The vinyl resins that may be used include polyvinyl chloride, polyvinyl acetate, copolymers of vinyl chloride and vinyl acetate, acrylic resins, methacrylic resins, polystyrene resins, and the like. The melamine resins include amino resins made by the condensation of melamine with formaldehyde or a compound capable of providing methylene bridges. The cross linking of the alkyd and/or vinyl resin with the melamine resin typically occurs when the first release coating layer 160 is applied to the release liner 150 and dried or cured. In one embodiment, the release coating layer 160 comprises on a solids basis from zero to about 80% by weight, and in one embodiment about 10 to about 30% by weight alkyd resin; from zero to about 80% by weight, and in one embodiment about 10 to about 30% by weight vinyl resin; and from about 10 to about 30% by weight, and in one embodiment about 20 to about 25% by weight melamine resin.

The first release coating layer 160 may contain one or more solid particulates that project into the surface 132 of the second transparent film layer 130 to provide the surface 132 with a matte or flat finish. When particulates are present, the first release coating layer 160 may be referred to as a matte release coat or matte release coating layer. The particulates that may be used may be any particulate filler or pigment normally used in paint formulations. Specific examples include talc and aluminum silicate. Particulates with irregular shapes (e.g., platelet shapes) may be used. By controlling the use of these particulates the surface finish of the upper surface 132 of the second transparent film layer 130 may be controlled. For example, by using these particulates, the upper surface 132 of the second transparent film layer 130 may be provided with a flat or semi-gloss finish. The upper surface 132 of the second transparent film 130 layer may be provided with a glossy finish by not using or minimizing the use of these particulates. The weight ratio of particulates to resin may range up to about 1.1:1, and in one embodiment about 0.7:1 to about 1.1:1, and in one embodiment from about 0.7:1 to about 0.9:1, and in one embodiment about 0.9:1 to about 1.1:1.

The release coating layers 170 and 190 and the release coating layer applied to release liner 280 may each comprise independently any release coating composition known in the art. Silicone release coating compositions may be used. The silicone release coating compositions typically comprise polyorganosiloxanes such as polydimethylsiloxanes. The silicone release coating composition used in this invention may be room temperature cured, thermally cured, or radiation cured. Generally, the room temperature and thermally curable compositions comprise at least one polyorganosiloxane and at least one catalyst (or curing agent) for such polyorganosiloxane(s). These compositions may also contain at least one cure accelerator and/or adhesivity promoter. As is known in the art, some materials have the capability of performing both functions, i.e., the capability of acting as a cure accelerator to increase the rate, reduce the curing temperature, etc., and also as an adhesivity promoter to improve bonding of the silicone composition to the substrate. The use of such dual function additives where appropriate is within the purview of the invention.

The ink receptive layer 200 may comprise one or more polyester resins. The polyester resins may be prepared from various glycols or polyols and one or more aliphatic or aromatic carboxylic acids. Examples of useful polyester resins include resins obtained by condensation polymerization of a diol having a bisphenol skeleton or alkylene skeleton with one or more divalent or trivalent carboxylic acid. In one embodiment, the bisphenol component may be modified with ethylene glycol or propylene glycol. Examples of suitable acid components for condensation with the polyols include fumaric acid, phthalic acid, terephthalic acid, isophthalic acid, maleic acid, succinic acid, adipic acid, citraconic acid, itaconic acid, sebacic acid, malonic acid, hexacarbonic acid and trimellitic acid.

The ink receptive layer 200 may be made from a coating composition which comprises from about 98 parts by weight to about 60 parts by weight of a polyester resin having a number average molecular weight (Mn) greater than about 12,000. The polyester resins having an Mn of greater than about 12,000 may be referred to herein as high molecular weight polyester resins. The coating compositions may also comprise from about 2 parts by weight to about 40 parts by weight of a polyester resin having an Mn in the range of from about 2,000 to about 12,000. The polyester resins having an Mn in the range of from about 2,000 to about 12,000 may be referred to herein as low molecular weight polyester resins. In one embodiment, the amount of the high molecular weight polyester resin contained in the coating composition may range from about 98 to about 70 parts by weight, or from about 98 parts to about 80 parts by weight. In yet another embodiment, the coating compositions may contain from about 98 to 90 parts by weight of the high molecular weight polyester resin. The amount of the low molecular weight polyester resin contained in the coating composition may, in other embodiments, range from about 2 parts by weight to about 10, 20 or 30 parts by weight. The parts by weight of the low molecular weight polyester resin and the high molecular weight polyester resin are based on the total weight of the polyester resin in the coating composition. In other embodiments, the high molecular weight polyester resin may have an Mn of from about 15,000 to about 40,000, and the low molecular weight polyester resin may have an Mn in the range of from about 3,000 to about 8,000 or from about 3,000 to about 5,000.

The following coating compositions may be used to make the ink receptive layer 200:

| | Percent |
|---|---|
| | by Weight |
| Ink Receptive Coating Composition No. 1 | |
| Methyl ethyl ketone | 10.03 |
| Toluene | 40.13 |
| Cyclohexanone | 14.47 |
| Vitel 2200 | 30.23 |
| FineTone 382ES (product of Reichold Chemicals identified | 1.60 |
| as a bisphenol-A fumarate polyester having an Mn = 4760; | |
| hydroxyl number = 39; and acid number = 21) | |
| Desmodur CB-75N crosslinker (product of Bayer | 3.53 |
| identified as oligomeric toluene diiosocyanate) | |
| | 100.00 |
| Ink Receptive Coating Composition No. 2 | |
| Methyl ethyl ketone | 21.88 |
| Toluene | 50.97 |
| Cyclohexanone | 4.74 |
| Vitel 2200 | 20.83 |
| FineTone 382ES | 1.10 |
| Neocryl CX-100 (product of Avecia Resins identified as | 0.47 |
| trimethylol-tris N (methyl aziridinyl) propionate and | |
| useful as a crosslinker) | |
| | 100.00 |
| Ink Receptive Coating Composition No. 3 | |
| Methyl ethyl ketone | 19.82 |
| Toluene | 50.83 |
| Cyclohexanone | 4.95 |
| Vitel 2200 | 20.70 |
| Finetone 382ES | 2.30 |
| Syloid 234 (synthetic amorphous silica | 0.50 |
| supplied by Grace Davidson) | |
| Neocryl CX-100 | 0.09 |
| | 100.00 |
| Ink Receptive Coating Composition No. 4 | |
| Toluene | 21.64 |
| Methyl isobutyl ketone | 46.36 |
| Zelec ECP-1410M (product of Milliken Chemical | 12.00 |
| identified as electroconductive powder) | |
| Elvacite 2010 (product of Ineous | 20.00 |
| identified as methyl methacrylate) | |
| | 100.00 |
| Prime for No. 5 Ink Receptive Coating Composition | |
| Adcote 69X100 (product of Rohm & Haas Co. | 17.50 |
| identified as formulated polyester resin) | |
| Toluene | 82.50 |
| | 100.00 |
| Ink Receptive Coating Composition No. 5 | |
| N-butanol | 25.76 |
| Isobutanol | 59.98 |
| Polyvinyl Pyrrolidone (product of ISP | 9.07 |
| Chemicals, Inc.) | |
| Gasil HP39 Silica (product of | 3.89 |
| Ineoss Silicas identified as Silica Gel) | |
| Acetic acid | 1.0 |
| Quinlon C (product of DuPont identified as a | 0.31 |
| chromium complex crosslinker) | |
| | 100.00 |

In one embodiment, the above Ink Receptive Coating Composition No. 1 is applied to a transparent film layer corresponding to transparent film layer 110 and dried, and then an ink layer is printed onto the resulting ink receptive layer using the above-indicated Sol Jet Pro II inkjet printer. The resulting multilayer film is tested for 500 kilo Joules exposure in a Xenon Weathermeter according to SAE J1885 specification. The multilayer film retains its original color and gloss after conclusion of the test.

The heat-activated or heat-activatable adhesive layer 210 may be made from any heat-activatable adhesive or thermoplastic film material. These include polyolefins (linear or branched), polyamides such as nylon, polyester copolymers, ionomers based on sodium or zinc salts of ethylene methacrylic acid, polyacrylonitriles, and ethylene-vinyl acetate copolymers. Included in this group are the acrylates such as ethylene methacrylic acid, ethylene methyl acrylate, ethylene acrylic acid and ethylene ethyl acrylate. Also, included in this group are polymers and copolymers of olefin monomers having, for example, 2 to about 12 carbon atoms, and in one embodiment 2 to about 8 carbon atoms. These include the polymers of α-olefins having from 2 to about 4 carbon atoms per molecule. These include polyethylene, polypropylene, poly-1-butene, etc. The polyolefins include amorphous polyolefins. The polyethylenes that are useful have various densities including low, medium and high density ranges as indicated above. Ethylene/methyl acrylate copolymers may be used. Polymer film materials prepared from blends of copolymers or blends of copolymers with homopolymers may be used. The heat-activated or heat-activatable adhesive layer 210 may have a lower melting point than the first transparent film layer 110. Typically, the melting point of the heat-activated or heat-activatable adhesive layer 210 may be in the range of about 80° C. to about 160° C., and in one embodiment about 120° C. to about 150° C.

The metalized layer 300 may be prepared from any metal which may be deposited on the first transparent film layer 110. In one embodiment, the metalized layer may be applied by vapor deposition. In one embodiment, the metalized layer is silver, gold or bronze in color. The metals used may include tin, chromium, nickel, stainless steel, copper, indium, gold, silver, aluminum, and alloys thereof.

In the embodiments illustrated in FIGS. 8, 10 and 11-17, the release force required to separate the second release liner 180 from the first adhesive layer 140 may be less than the release force required to separate first release liner 150 from the second transparent film layer 130. In one embodiment, the release force required to separate the first release liner 150 from the second transparent film layer 130 is in the range of about 20 to about 100 grams per two inches (g/2 in), and in one embodiment about 30 to about 75 g/2 in, and in one embodiment about 45 to about 65 g/2 in). In one embodiment, the release force required to separate the second release liner 180 from the adhesive layer 140 is in the range of about 5 to about 50 g/2 in, and in one embodiment about 10 to about 30 g/2 in, and in one embodiment about 20 to about 30 g/2 in. The test method for determining these release forces involves measuring the force required to separate a two-inch wide liner coated with the second release coating layer 190 from a substrate coated with the first adhesive layer 140, or a two-inch wide liner coated with the first release coating layer 160 from a substrate coated with the second transparent film layer 130, with the liner extending at an angle of 90° relative to the adhesive layer 140 or film layer 130 and being pulled at a rate of 300 inches per minute.

Each of the layers 110, 120, 130, 140, 160, 170, 190, 200, 210, 290 and 295 may be applied and dried and/or cured using known techniques. The application techniques include one or more of gravure, reverse gravure, offset gravure, roll coating, brushing, knife-over roll, metering rod, reverse roll coating, doctor knife, dipping, die coating, slot die coating, spraying, curtain coating, slide coating, slide curtain coating, extrusion, co-extrusion, flexographic, letter press, rotary screen, flat screen, and the like. In one embodiment, the adhesive layers 140, 290 and/or 295 are pressure sensitive adhesive layers which may be applied using transfer lamination, die coating or extrusion. The layers 110 and 130 may be die coated or extruded. In one embodiment, the first transparent film layer 110 may be coextruded with the adhesive layer 140. The ink layer 120 may be applied using known printing techniques including gravure, flexographic, silk screen, ink jet, etc. The applied layers may be dried and/or cured by exposure to heat or to known forms of ionizing or actinic non-ionizing radiation. Drying or curing temperatures that may be used may range from about 30° C. to about 180° C., and in one embodiment about 110° C. to about 150° C. Useful types of radiation include ultraviolet light and electron beam. The equipment for generating these forms of thermal or radiation drying and/or curing are well known to those skilled in the art.

The multilayer film 100B illustrated in FIG. 3 may be made by applying the third release coating layer 170 to the upper surface 152 of first release liner 150 using one of the above-indicated techniques, and drying or curing the third release coating layer 170. The coat weight for the third release coating layer 170 may range from about 0.1 to about 2 grams per square meter (gsm), and in one embodiment about 0.1 to about 1.5 gsm, and in one embodiment about 0.2 to about 1 gsm. The first release coating layer 160 may be applied to the lower surface 154 of the first release liner 150 using one of the foregoing application techniques, and dried or cured. The coat weight for the first release coating layer 160 may be in the range of about 1.5 to about 7 gsm, and in one embodiment about 2 to about 6 gsm, and in one embodiment about 4 to about 5 gsm. The second transparent film layer 130 may be applied to the lower surface 164 of the release coating layer 160 using one of the above indicated application techniques, and dried or cured. The coat weight for the second transparent film layer 130 may range from about 3 to about 27 gsm, and in one embodiment about 5 to about 27 gsm, and in one embodiment about 10 to about 27 gsm, and in one embodiment about 15 to about 27 gsm, and in one embodiment about 18 to about 27 gsm, and in one embodiment about 21 to about 27 gsm. The ink layer 120 may be applied to the lower surface 134 of the second transparent film layer 130 using one of the above-indicated techniques, and dried or cured. The coat weight for the ink layer 120 may range from about 0.5 to about 4 gsm, and in one embodiment about 0.5 to about 2 gsm. The first transparent film layer 110 may be applied to the lower surface 124 of the ink layer 120 using one of the above indicated application techniques, and dried or cured. The coat weight for the first transparent film layer 110 may range up to about 27 gsm, and in one embodiment about 6 to about 12 gsm. One or more coats of the first transparent film layer 110 may be applied. The first adhesive layer 140 may be applied to the lower surface 114 of the first transparent film layer 110 using one of the above indicated application techniques, and dried or cured. In this embodiment, the first adhesive layer 140 may comprise a pressure sensitive adhesive. The first adhesive layer 140 may be applied using transfer lamination, die coating or extrusion. The coat weight for the first adhesive layer 140 may range from about 10 to about 75 gsm, and in one embodiment about 10 to about 50 gsm, and in one embodiment about 10 to about 25 gsm, and in one embodiment about 12 to about 18 gsm. The multilayer film 100B may be wound in a roll for shipping and handling as indicated in FIG. 9.

The multilayer film 100 illustrated in FIG. 1 may be made from the multilayer film 100B illustrated in FIG. 3 by separating the first release liner 150 and the first release coating layer 160 from the remainder of the multilayer film. The third release coating layer 170 separates from the multilayer film with the first release liner 150.

The multilayer film 100G illustrated in FIG. 8 may be prepared using the following process steps. In a first process step partial film construction 220 may be made and in a second process step partial film construction 230 may be made. The multilayer film 100G may be assembled by adhering the partial film construction 220 to the partial film construction 230. Partial film construction 220 may be prepared by applying second release coating layer 190 to second release liner 180 using one of the above techniques, and curing or drying the second release coating layer 190. The coat weight for the second release coating layer 190 may range from about 0.1 to about 2 gsm, and in one embodiment from about 0.2 to about 1 gsm. The first adhesive layer 140, which is in the form of a pressure sensitive adhesive, may be applied to the second release coating layer 190 using one of the above-indicated techniques. The adhesive layer may be applied using transfer lamination, die coating or extrusion. The first adhesive layer 140 may be applied at a coat weight of about 10 to about 25 gsm, and in one embodiment about 10 to about 20 gsm. Partial film construction 230 may be prepared by applying first release coating layer 160 to first release liner 150 using one of the above-indicated application techniques, and drying or curing the first release coating layer 160. The first release coating layer 160 may be applied at a coat weight of about 1.5 to about 7 gsm, and in one embodiment about 4 to about 5 gsm. The second transparent film layer 130 may be applied to the first release coating layer 160 using one of the above-indicated techniques, and dried or cured. One or more coats of the second transparent film layer 130 may be applied. The second transparent film layer 130 may be applied at a coat weight of about 3 to about 27 gsm, and in one embodiment about 21 to about 27 gsm. The ink layer 120 may be applied to the second transparent film layer 130 using one of the above-indicated techniques, and dried or cured. The coat weight for the ink layer 120 may range from about 0.3 to about 2 gsm, and in one embodiment about 0.5 to about 1 gsm. The first transparent film layer 110 may be applied to the ink layer 120 using one of the above-indicated techniques, and dried or cured. One or more coats of the first transparent film layer 110 may be applied. The first transparent film layer 110 may be applied at a coat weight of about 3 to about 27 gsm, and in one embodiment about 12 to about 18 gsm. The multilayer film 100G may be assembled using known techniques by adhering the partial film construction 220 to the partial film construction 230 with the lower surface 114 of the first transparent film layer 110 contacting the upper surface 142 of the first adhesive layer 140.

The multilayer film 100A illustrated in FIG. 2 may be made from the multilayer film 100G illustrated in FIG. 8 by separating the second release liner 180 and the second release coating layer 190 from the remainder of the multilayer film.

The multilayer film 100C illustrated in FIG. 4 may be made from the multilayer film 100G illustrated in FIG. 8 by separating the first release liner 150 and the first release coating layer 160 from the remainder of the multilayer film.

The multilayer film 100E illustrated in FIG. 6 may be made in the same way as the multilayer film 100G illustrated in FIG. 8 with the exception that ink receptive layer 200 may be applied to the second transparent film layer 130, and then the ink layer 120 may be applied to the ink receptive layer 200. The ink receptive layer 200 may be applied using any of the above-indicated application techniques, and dried or cured. The coat weight for the ink receptive layer 200 may range from about 1 to about 5 gsm, and in one embodiment about 2 to about 3.5 gsm. The second release liner 180 and second release coating layer 190, and the first release liner 150 and first release coating layer 160, may be separated from the remainder of the multilayer film to provide the multilayer film 100E.

The multilayer film 100H illustrated in FIG. 10 may be made using the following process steps. In a first process step partial film construction 240 may be made and in a second process step partial film construction 250 may be made. The multilayer film 100H may be assembled by adhering the partial film construction 240 to the partial film construction 250. The partial film construction 240 may be made by coating second release liner 180 with second release coating layer 190, and drying or curing the second release coating layer 190. The second release coating layer 190 may be applied at a coat weight of about 0.1 to about 2 gsm, and in one embodiment about 0.2 to about 1 gsm. The first adhesive layer 140, which is in the form of a pressure sensitive adhesive layer, is applied to the second release coating layer 190 using one of the above-indicated techniques. The first adhesive layer 140 may be applied using transfer lamination, die coating or extrusion. The first adhesive layer 140 may be applied at a coat weight of about 10 to about 25 gsm, and in one embodiment about 12 to about 18 gsm. The first transparent film layer 110 may be applied to the first adhesive layer 140 using one of the above-indicated techniques, and dried or cured. The first transparent film layer 110 may be applied at a coat weight of up to about 27 gsm, and in one embodiment about 6 to about 12 gsm. One or more coats of the first transparent film layer 110 may be applied. Ink receptive layer 200 may be applied to the upper surface 112 of the first transparent film layer 110 using one of the above-identified techniques, and dried or cured. The ink receptive layer 200 may be applied at a coat weight of about 1 to about 5 gsm, and in one embodiment about 2 to about 3.5 gsm. The ink layer 120 may be applied to the ink receptive layer 200 using one of the above-indicated techniques, and dried or cured. The ink layer 120 may be applied at a coat weight of about 0.5 to about 4 gsm, and in one embodiment about 0.5 to about 2 gsm. The partial film construction 250 may be made by applying first release coating layer 160 to the first release liner 150 using one of the above-indicated techniques, and then drying or curing the first release coating layer 160. The first release coating layer 160 may be applied at a coat weight of about 1.5 to about 7 gsm, and in one embodiment about 4 to about 5 gsm. The second transparent film layer 130 may be applied to the first release coating layer 160 using one of the above-indicated techniques, and dried or cured. One or more coats may be applied. The coat weight for the second transparent film layer 130 may range from about 3 to about 27 gsm, and in one embodiment 5 to about 27 gsm, and in one embodiment 10 to about 27 gsm, and in one embodiment 15 to about 27 gsm, and in one embodiment 18 to about 27 gsm, and in one embodiment about 21 to about 27 gsm. The partial film construction 240 may be adhered to the partial film construction 250 with the lower surface 134 of the second transparent film layer 130 in contact with the ink layer 120.

The multilayer film 100D illustrated in FIG. 5 may be made from the multilayer film 100H illustrated in FIG. 10 by separating the second release liner 180 and second release coating layer 190, and the first release liner 150 and the first release coating layer 160, from the remainder of the multilayer film.

The multilayer film 1001 illustrated in FIG. 11 may be assembled by making partial film constructions 260 and 270 in separate steps, and then adhering the partial film constructions to each other. The partial film construction 260 may be made by coating second release liner 180 with second release coating layer 190 using one of the above-indicated application techniques, and dried or cured. The coat weight for the second release coating layer 190 may range from about 0.1 to about 2 gsm, and in one embodiment about 0.2 to about 1 gsm. The first adhesive layer 140, which is in the form of a pressure sensitive adhesive, may be applied to the second release coating layer 190. The first adhesive layer 140 may be applied using one of the above-indicated application techniques, for example, transfer lamination, die coating or extrusion. The first transparent film layer 110 may be applied to the first adhesive layer 140 using one of the above-indicated techniques, and dried or cured. One or more coats of the first transparent film layer 110 may be applied. The coat weight for the first transparent film layer 110 may range up to about 27 gsm, and in one embodiment about 6 to about 12 gsm. The first transparent film layer 110 and the first adhesive layer 140 may be coextruded onto the release coating layer 190 of the second release liner 180. Heat-activatable adhesive layer 210 may be applied to the first transparent film layer 110 using one of the above-indicated techniques. The heat-activatable adhesive layer 210 may be applied at a coat weight of about 1.5 to about 5 gsm, and in one embodiment about 2.5 to about 3.5 gsm. The partial film construction 270 may be made by applying first release coating layer 160 to first release liner 150 using one of the above-indicated techniques, and drying or curing the first release coating layer 160. The first release coating layer 160 may be applied at a coat weight of about 1.5 to about 7 gsm, and in one embodiment about 4 to about 5 gsm. The second transparent film layer 130 may be applied to the first release coating layer 160 using one of the above-indicated techniques, and dried or cured. The coat weight for the second transparent film layer 130 may range from about 3 to about 27 gsm, and in one embodiment about 21 to about 27 gsm. Ink receptive layer 200 may be applied to the second transparent film layer 130 using one of the above-indicated application techniques, and dried or cured. The coat weight for the ink receptive layer 200 may range from about 1 to about 5 gsm, and in one embodiment about 2 to about 3.5 gsm. Ink layer 120 may be applied to the ink receptive layer 200 using one of the above-indicated application techniques, and dried or cured. The ink layer 120 may be applied at a coat weight of about 0.5 to about 4 gsm, and in one embodiment about 0.5 to about 1 gsm. The partial film construction 260 may be adhered to the partial film construction 270 using sufficient heat to activate the heat-activatable adhesive layer 210, the heat-activatable adhesive layer 210 being in contact with the ink layer 120.

The multilayer film 100F illustrated in FIG. 7 may be made using the same procedure as the procedure for making the multilayer film 100I illustrated in FIG. 11 with the exception that the ink receptive layer 200 is not employed. As a result the ink layer 120 may be applied to the second transparent film layer 130, rather than to the ink receptive layer 200. The second release liner 180 and release coating layer 190, and the first release liner 150 and first release coating layer 160, may be separated from the remainder of the multilayer film to provide the multilayer film 100F.

The multilayer film 100J illustrated in FIG. 12 may be made by first making the partial film construction 310 and the partial film construction 320, and then combining the partial film constructions. The partial film constructions 310 and 320 may be supplied to a user who may apply an ink layer 120 to the ink receptive layer 200 before combining the partial film constructions to make the multilayer film 100J. The partial film construction 310 may be made by applying third release coating layer 170 to one side of first release liner 150 and applying first release coating layer 160 to the other side of first release liner 150. The third release coating layer 170 may be applied using one of the above-indicated techniques and then dried or cured. The coat weight for the third release coating layer 170 may range from about 0.1 to about 2 gsm, and in one embodiment about 0.1 to about 1.5 gsm, and in one embodiment about 0.2 to about 1 gsm. The first release coating layer 160 may be applied using one of the foregoing application techniques, and then dried or cured. The coat weight for the first release coating layer 160 may range from about 1.5 to about 7 gsm, and in one embodiment about 2 to about 6 gsm, and in one embodiment about 4 to about 5 gsm. The second transparent film layer 130 may be applied to the release coating layer 160 using one of the above-indicated application techniques, and dried or cured. The coat weight for the second transparent film layer 130 may range from about 3 to about 27 gsm, and in one embodiment about 5 to about 7 gsm, and in one embodiment about 10 to about 27 gsm, and in one embodiment about 15 to about 27 gsm, and in one embodiment about 18 to about 27 gsm, and in one embodiment about 21 to about 27 gsm. The first transparent film layer 110 may be applied to the second transparent film layer 130 using one of the above-indicated application techniques, and dried or cured. The coat weight for the first transparent film layer 110 may range up to about 27 gsm, and in one embodiment about 6 to about 12 gsm. In one embodiment, the second transparent film layer 130 and the first transparent film layer 110 may be die coated or extruded sequentially or they may be coextruded using a multi-die extruder. The ink receptive layer 200 may be applied to the first transparent film layer 110 using one of the above-indicated application techniques, and dried or cured. The ink receptive layer 200 may be applied at a coat weight of about 1 to about 5 gsm, and in one embodiment about 2 to about 3.5 gsm. The partial film construction 320 may be made by applying second release coating layer 190 to second release liner 180 using one of the above-indicated techniques and then curing or drying the second release coating layer. The coat weight for the second release coating layer 190 may range from about 0.1 to about 2 gsm, and in one embodiment about 0.2 to about 1 gsm. The first adhesive layer 140, which may be in the form of a pressure sensitive adhesive, may be applied to the second release coating layer 190 using one of the above-indicated techniques. The first adhesive layer 140 may be applied using transfer lamination or extrusion. The first adhesive layer 140 may be applied at a coat weight of about 10 to about 75 gsm, and in one embodiment about 10 to about 50 gsm, and in one embodiment about 10 to about 25 gsm, and in one embodiment about 12 to about 18 gsm. Third release liner 280 may be applied to first adhesive layer 140 with the release coating adhered to the third release liner 280 contacting the first adhesive layer 140. The multilayer film 100J may be assembled after applying an ink layer 120 to the ink receptive layer 200 as described above.

The multilayer film 100K illustrated in FIG. 13 may be made by applying the third release coating layer 170 to the upper surface 152 of first release liner 150 using one of the above-indicated techniques, and drying or curing the third release coating layer 170. The coat weight for the third release coating layer 170 may range from about 0.1 to about 2 gsm, and in one embodiment about 0.1 to about 1.5 gsm, and in one embodiment about 0.2 to about 1 gsm. The multilayer film 100K may then be made following the above-indicated procedure for making the multilayer film 100G illustrated in FIG. 8.

The multilayer film 100L illustrated in FIG. 14 may be prepared using the following process steps. In a first process step partial film construction 330 may be made and in a second process step partial film construction 340 may be made. The multilayer film 100L may be assembled by adhering the partial film construction 330 to the partial film construction 340. As indicated above, the multilayer film 100L may be assembled using known techniques after the user applies an ink layer 120 to the ink receptive layer 200. Partial film construction 340 may be made by applying second release coating layer 190 to second release liner 180 using one of the above techniques, and curing or drying the second release coating layer 190. The coat weight for the second release coating layer 190 may range from about 0.1 to about 2 gsm, and in one embodiment from about 0.2 to about 1 gsm. The first adhesive layer 140, which is in the form of a pressure sensitive adhesive, may be applied to the second release coating layer 190 using one of the above-indicated techniques. The adhesive layer may be applied using transfer lamination, die coating or extrusion. The first adhesive layer 140 may be applied at a coat weight of about 10 to about 25 gsm, and in one embodiment about 10 to about 20 gsm. The first transparent film layer 110 is applied to the adhesive layer 140 using one of the above-indicated techniques, and dried or cured. One or more coats of the first transparent film layer 110 may be applied. The film layer 110 and adhesive layer 140 may coextruded. The first transparent film layer 110 may be applied at a coat weight of up to about 27 gsm, and in one embodiment about 6 to about 12 gsm. Heat-activatable adhesive layer 210 may be applied to the first transparent film layer 110 using one of the above-indicated techniques. The heat-activatable adhesive layer 210 may be applied at a coat weight of about 1.5 to about 5 gsm, and in one embodiment about 2.5 to about 3.5 gsm. Partial film construction 330 may be prepared by applying first release coating layer 160 to first release liner 150 using one of the above-indicated application techniques, and drying or curing the first release coating layer 160. The first release coating layer 160 may be applied at a coat weight of about 1.5 to about 7 gsm, and in one embodiment about 4 to about 5 gsm. The second transparent film layer 130 may be applied to the first release coating layer 160 using one of the above-indicated techniques, and dried or cured. One or more coats of the second transparent film layer 130 may be applied. The second transparent film layer 130 may be applied at a coat weight of about 3 to about 27 gsm, and in one embodiment about 21 to about 27 gsm. The ink receptive layer 200 may be applied to the second transparent film layer 130 using one of the above-indicated techniques, and dried or cured. The coat weight for the ink receptive layer 200 may range from about 1 to about 5 gsm, and in one embodiment about 2 to about 3.5 gsm.

The multilayer film 100M illustrated in FIG. 15 may be prepared using the following process steps. In a first process step partial film construction 350 may be made and in a second process step partial film construction 360 may be made. The multilayer film 100M may be assembled by adhering the partial film construction 350 to the partial film construction 360 using known techniques. An ink layer 120 may be applied to the ink receptive layer 200 prior to assembling the multilayer film 100M. Partial film construction 360 may be prepared by applying second release coating layer 190 to second release liner 180 using one of the above techniques, and curing or drying the second release coating layer 190. The coat weight for the second release coating layer 190 may range from about 0.1 to about 2 gsm, and in one embodiment from about 0.2 to about 1 gsm. The first adhesive layer 140, which is in the form of a pressure sensitive adhesive, may be applied to the second release coating layer 190 using one of the above-indicated techniques. The adhesive layer may be applied using transfer lamination, die coating or extrusion. The first adhesive layer 140 may be applied at a coat weight of about 10 to about 25 gsm, and in one embodiment about 10 to about 20 gsm. The first transparent film layer 110 may be applied to the adhesive layer 140 using one of the above-indicated techniques, and dried or cured. One or more coats of the first transparent film layer 110 may be applied. The film layer 110 and the adhesive layer 140 may be coextruded. The first transparent film layer 110 may be applied at a coat weight of up to about 27 gsm, and in one embodiment about 6 to about 12 gsm. The second adhesive layer 290 is applied to the transparent film layer 110 using one of the above-indicated application techniques, and dried or cured. The second adhesive layer 290 may be applied using transfer lamination or extrusion. The adhesive layer 290 may be coextruded with the film layer 110. The coat weight for the second adhesive layer 290 may range from about 10 to about 75 gsm, and in one embodiment about 10 to about 50 gsm, and in one embodiment about 10 to about 25 gsm, and in one embodiment about 12 to about 18 gsm. Partial film construction 350 may be prepared by applying first release coating layer 160 to first release liner 150 using one of the above-indicated application techniques, and drying or curing the first release coating layer 160. The first release coating layer 160 may be applied at a coat weight of about 1.5 to about 7 gsm, and in one embodiment about 4 to about 5 gsm. The second transparent film layer 130 may be applied to the first release coating layer 160 using one of the above-indicated techniques, and dried or cured. One or more coats of the second transparent film layer 130 may be applied. The second transparent film layer 130 may be applied at a coat weight of about 3 to about 27 gsm, and in one embodiment about 21 to about 27 gsm. The ink receptive layer 200 may be applied to the second transparent film layer 130 using one of the above-indicated techniques, and dried or cured. The coat weight for the ink receptive layer 200 may range from about 1 to about 5 gsm, and in one embodiment about 2 to about 3.5 gsm.

The multilayer film 100N illustrated in FIG. 16 may be prepared using the following process steps. In a first process step partial film construction 370 is made and in a second process step partial film construction 380 is made. The multilayer film 100N may be assembled by adhering the partial film construction 370 to the partial film construction 380 using known techniques. An ink layer 120 may be applied to the ink receptive layer 200 prior to assembling the multilayer film 100. Partial film construction 380 may be prepared by applying second release coating layer 190 to second release liner 180 using one of the above techniques, and curing or drying the second release coating layer 190. The coat weight for the second release coating layer 190 may range from about 0.1 to about 2 gsm, and in one embodiment from about 0.2 to about 1 gsm. The first adhesive layer 140, which is in the form of a pressure sensitive adhesive, may be applied to the second release coating layer 190 using one of the above-indicated techniques. The adhesive layer may be applied using transfer lamination, die coating or extrusion. The first adhesive layer 140 may be applied at a coat weight of about 10 to about 25 gsm, and in one embodiment about 10 to about 20 gsm. The first transparent film layer 110 may be applied to the adhesive layer 140 using one of the above-indicated techniques, and dried or cured. One or more coats of the first transparent film layer 110 may be applied. The film layer 110 and the adhesive layer 140 may be coextruded. The first transparent film layer 110 may be applied at a coat weight of up to about 27 gsm, and in one embodiment about 6 to about 12 gsm. The ink receptive layer 200 may be applied to the first transparent film layer 110 using one of the above-indicated techniques, and dried or cured. The coat weight for the ink receptive layer 200 may range from about 1 to about 5 gsm, and in one embodiment about 2 to about 3.5 gsm. Partial film construction 370 may be prepared by applying first release coating layer 160 to first release liner 150 using one of the above-indicated application techniques, and drying or curing the first release coating layer 160. The first release coating layer 160 may be applied at a coat weight of about 1.5 to about 7 gsm, and in one embodiment about 4 to about 5 gsm. The second transparent film layer 130 may be applied to the first release coating layer 160 using one of the above-indicated techniques, and dried or cured. One or more coats of the second transparent film layer 130 may be applied. The second transparent film layer 130 may be applied at a coat weight of about 3 to about 27 gsm, and in one embodiment about 21 to about 27 gsm. The third adhesive layer 295 may be applied to the second transparent film layer 130 using one of the above-indicated techniques. The third adhesive layer 295 may be applied using transfer lamination or extrusion. The third adhesive layer 295 and film layer 130 may be coextruded. The third adhesive layer 295 may be applied at a coat weight of about 10 to about 25 gsm, and in one embodiment about 10 to about 20 gsm.

The multilayer film 100P illustrated in FIG. 17 may be prepared using the following process steps. In a first process step partial film construction 390 may be made and in a second process step partial film construction 400 may be made. The multilayer film 100P may be assembled by adhering the partial film construction 390 to the partial film construction 400. Partial film construction 400 may be prepared by applying second release coating layer 190 to second release liner 180 using one of the above techniques, and curing or drying the second release coating layer 190. The coat weight for the second release coating layer 190 may range from about 0.1 to about 2 gsm, and in one embodiment from about 0.2 to about 1 gsm. The first adhesive layer 140, which is in the form of a pressure sensitive adhesive, may be applied to the second release coating layer 190 using one of the above-indicated techniques. The adhesive layer may be applied using transfer lamination, die coating or extrusion. The first adhesive layer 140 may be applied at a coat weight of about 10 to about 25 gsm, and in one embodiment about 10 to about 20 gsm. Partial film construction 390 may be prepared by applying first release coating layer 160 to first release liner 150 using one of the above-indicated application techniques, and drying or curing the first release coating layer 160. The first release coating layer 160 may be applied at a coat weight of about 1.5 to about 7 gsm, and in one embodiment about 4 to about 5 gsm. The second transparent film layer 130 may be applied to the first release coating layer 160 using one of the above-indicated techniques, and dried or cured. One or more coats of the second transparent film layer 130 may be applied. The second transparent film layer 130 may be applied at a coat weight of about 3 to about 27 gsm, and in one embodiment about 21 to about 27 gsm. Optionally, an ink layer 120 may be applied to the second transparent film layer 130 using one of the above-indicated techniques, and dried or cured. The coat weight for the ink layer 120 may range from about 0.3 to about 2 gsm, and in one embodiment about 0.5 to about 1 gsm. The first transparent film layer 110 may be applied to the second transparent film layer 130 or the ink layer 120 using one of the above-indicated techniques, and dried or cured. One or more coats of the first transparent film layer 110 may be applied. The first transparent film layer 110 may be applied at a coat weight of up to about 27 gsm, and in one embodiment about 6 to about 12 gsm. The metalized layer 300 may be applied to first transparent film layer using, for example, vapor deposition.

In one embodiment, these multilayer films may be converted by die cutting the multilayer film down to the surface of the liner to outline a decal, and stripping out the waste material surrounding the decal (matrix). For example, the multilayer films 100C, 100G, 100H, 100I, 100J, 100K, 100L, 100M, 100N and 100P may be die cut down to second release coating layer 190. The decal may then be adhered to a substrate surface by separating the decal from the liner and causing the adhesive layer 140 of the decal to come into contact with the substrate surface. In one embodiment, the decal may be separated from the liner by bending the liner back over a peel plate, whereupon the decal is sufficiently stiff to cause the decal to continue on a straight path toward the desired substrate surface.

The inventive multilayer film may be made in a single production line or in multiple production lines or multiple production facilities. With multiple production lines or facilities, part of the multilayer film may be produced as a roll multilayer film, dried or cured, rolled up, transferred to the next production line or facility, unrolled, and further treated with the application of additional layers. For example, the first transparent film layer 110 and the adhesive layer 120 may be deposited in multiple lines, or they may be deposited in sequence in a single line, or they may be deposited simultaneously such as by coextrusion or multi-die coating methods. Production in a single production line may be more efficient by avoiding extra handling, storage, and transporting steps for what may comprise, at least in one embodiment, relatively thin and delicate film materials.

The multilayer film 100B may be used by unrolling the multilayer film from the roll illustrated in FIG. 9, and simultaneously applying the multilayer film to the substrate to be covered. The substrate may comprise any flat surface. The flat surface may comprise wall board, plastic sheet, metal sheet, wood, glass, composites, and the like. The substrate may comprise a painted or coated surface. The substrate may comprise an interior (i.e., indoor) surface or an exterior (i.e., outdoor) surface. The substrate may comprise a vehicle interior or exterior surface, a furniture surface, a personal item, and the like. The gloss of the multilayer film may be designed to match the gloss of the substrate which, in one embodiment, permits the multilayer film to appear to be part of the substrate with just the pictorial design or printed message being visible. The multilayer film is placed over the substrate with the adhesive layer 140 in contact with the substrate. An advantage of using this multilayer film, at least in one embodiment, is that it is possible to overlap part of the applied multilayer film with the next adjacent applied multilayer film due to the fact that the seams substantially disappear and therefore are not noticeable. This advantage is provided at least in part due to the fact that the first transparent film layer 110 and second transparent film layer 130 are relatively thin. This advantage may also be achieved using films having a relatively low gloss.

The multilayer films 100, 100D, 100E and 100F may be applied to a substrate with the first adhesive layer 140 in contact with the substrate. The multilayer films 100A and 100B may be applied in the same manner with the exception that the first release liner 150 and first release coating layer 160 (and third release coating layer 170 for multilayer film 100B) may be separated from the remainder of the multilayer film after the multilayer film is applied to the substrate. This permits the multilayer film to be pressed onto the substrate without damaging the multilayer film.

The multilayer film 100C may be applied to a substrate after separating the second release liner 180 and second release coating layer 190 from the remainder of the substrate. The multilayer film is then adhered to the substrate with the first adhesive layer 140 in contact with the substrate.

The multilayer films 100G, 100H, 100I, 100J, 100K, 100L, 100M, 100N and 100P may be applied to a substrate by first removing the second release liner 180 and second release coating layer 190 from the remainder of the substrate, and then applying the multilayer film to the substrate with the first adhesive layer 140 in contact with the substrate. The first release liner 150 and the first release coating layer 160 are then separated from the multilayer film.

### EXAMPLE 1

A polyethylene terephthalate film release liner corresponding to first release liner 150 is coated on one side with a silicone release coating corresponding to third release coating layer 170. The thickness of the release coated liner is 0.92 mil.

A matte release coat corresponding to first release coating layer 160 is applied to the other side of the backing liner using gravure at a coat weight of 4.5 gsm. The formulation for the matte release coat is as follows: 26% by weight methylisobutyl ketone, 6% by weight isopropanol, 34.8% by weight Lankyd 13-1245 (a product supplied by Akzo Resins identified as an acrylic modified alkyd), 2.6% by weight Elvacite 2042 (a product supplied by Lucite International identified as a polyethyl methacrylate polymer), 30% by weight Microtalc MP 15-38 (a product supplied by Barrett's Minerals identified as a talc extender pigment), 2.5% by weight Cycat 4040 (a product supplied by Cytec identified as paratoluene sulfonic acid) and 8.7% by weight Cymel 303 (a product suppled by Cytec identified as a melamine resin). The matte release coat is dried using forced hot air at a temperature of 149° C.

A transparent film layer corresponding to second transparent film layer 130 is applied to the matte release coat using gravure at a coat weight of 25 gsm and dried using forced hot air at a temperature of 120° C. The formulation for the second transparent film layer 130 is as follows: 42.4% by weight methyl ethyl ketone, 21.2% by weight toluene, 28% by weight VYHH, and 8.4% Edenol 9790.

An ink layer corresponding to ink layer 120 is applied to the transparent film layer corresponding to film layer 130 using a sponge design gravure cylinder. The ink layer has the following formulation: 50.5% by weight methyl ethyl ketone, 26.2% by weight toluene, 6.4% by weight PM Acetate (solvent supplied by Dow Chemical), 14.1% by weight VYHH, 0.5% by weight 345-36500 (Naphthol red from Gibraltar Chemical), 1.4% by weight 345-34130 (Phthalo blue from Gibraltar), and 0.9% by weight 345-39420 (carbon black from Gibraltar). The ink layer is applied at a coat weight of about 0.4 gsm, and dried using forced hot air at temperature of 120° F.

A transparent film layer corresponding to first transparent film layer 110 is applied to the ink layer using a roll coater at a coat weight of 25 gsm and dried using forced hot air at a temperature of 120° C. The formulation for the first transparent film layer 110 is as follows: 38.18% by weight methyl ethyl ketone, 19.06% by weight toluene, 28.85% by weight VYHH, and 14.1 1% Edenol 9790.

A pressure sensitive adhesive layer corresponding to the first adhesive layer 140 is then applied to the transparent film layer corresponding to first transparent film layer 110 at a coat weight of 15 gsm using transfer lamination. The formulation for the pressure sensitive adhesive is as follows: 96% by weight of a non-tackified emulsion containing a crosslinked copolymer of butyl acrylate and ethyl hexyl acrylate, 3.7% by weight UCD 1106E (product of Rohm and Haas identified as titanium dioxide concentrate) and 0.3% by weight UCD 1507E (product of Rohm and Haas identified as a carbon black dispersion concentrate).

While the invention has been explained in relation to its preferred embodiments, it is to be understood that various modifications thereof will become apparent to those skilled in the art upon reading the specification. Therefore, it is to be understood that the invention disclosed herein is intended to cover such modifications as fall within the scope of the appended claims.

1-46. (canceled)

47. A method of making a multilayer film, comprising:
applying a first release coating layer to a first release liner, the first release liner having an upper surface and a lower surface, the first release coating layer being applied to the lower surface of the first release liner;
applying a third release coating layer to upper surface of the first release liner;
applying a second transparent film layer to the first release coating layer;
applying an ink layer or an ink receptive layer to the second transparent film layer;
applying a first transparent film layer to the ink layer or ink receptive layer; and
applying a first adhesive layer to the first transparent film layer.

48. A method of making a multilayer film, comprising:
applying a first release coating layer to a first release liner, the first release liner having an upper surface and a lower surface, the first release coating layer being applied to the lower surface of the first release liner;
applying a third release coating layer to upper surface of the first release liner;
extruding a second transparent film layer over the first release coating layer;
applying an ink layer or an ink receptive layer to the second transparent film layer;
extruding a first transparent film layer over the ink layer or ink receptive layer; and
extruding a first adhesive layer over the first transparent film layer.

49. A method of making a multilayer film, comprising:
applying a first release coating layer to a first release liner, the first release liner having an upper surface and a lower surface, the first release coating layer being applied to the lower surface of the first release liner;
applying a third release coating layer to upper surface of the first release liner;
extruding a second transparent film layer over the first release coating layer;
applying an ink layer or an ink receptive layer to the second transparent film layer; and
coextruding a first transparent film layer and a first adhesive layer over the ink layer or ink receptive layer, the first transparent film layer overlying the ink layer or ink receptive layer and the first adhesive layer overlying the first transparent film layer.

50. A method of making a multilayer film, comprising:
forming a first partial film construction by applying a first release coating layer to a first release liner, the first release liner having an upper surface and a lower surface, the first release coating layer being applied to the lower surface of the first release liner and applying a second transparent film layer to the first release coating layer;
forming a second partial film construction by applying a second release coating layer to a second release liner, the second release liner having an upper surface and a lower surface, the second release coating layer being applied to the upper surface of the second release liner, applying a first adhesive layer to the second release coating layer, applying a first transparent film layer to the first adhesive layer and applying an ink layer or an ink receptive layer to the first transparent film layer; and
adhering the first partial film construction to the second partial film construction with the second transparent film layer in contact with the ink layer or ink receptive layer to form the multilayer film.

51. A method of applying a multilayer film to a substrate, the multilayer film, comprising
a first transparent film layer having an upper surface and a lower surface;
a second transparent film layer overlying the upper surface of the first transparent film layer;
an ink layer, ink receptive layer or metalized layer overlying and adhered to a surface of the first transparent film layer or a surface of the second transparent film layer; and
a first adhesive layer overlying the lower surface of the first transparent film layer, the method comprising:
placing the multilayer film over the substrate with the adhesive layer in contact with the substrate and adhering the multilayer film to the substrate.

52. A method of applying a multilayer film to a substrate, the multilayer film, comprising:
a first transparent film layer having an upper surface and a lower surface;
an ink layer or an ink receptive layer overlying the upper surface of the first transparent film layer;
a second transparent film layer overlying the ink layer or ink receptive layer;
a first release liner overlying the second transparent film layer, the first release liner having an upper surface and a lower surface;
a first release coating layer overlying the lower surface of the first release liner and positioned between the first release liner and the second transparent film layer;
a third release coating layer overlying the upper surface of the first release liner; and
a first adhesive layer overlying the lower surface of the first transparent film layer;
the multilayer film being wound in a roll with the first adhesive layer in contact with the third release coating layer, the method comprising:
unwinding the roll with the first adhesive layer separating from the third release coating layer;
placing the multilayer film over the substrate with the first adhesive layer in contact with the substrate and adhering the multilayer film to the substrate; and
separating the first release liner from the multilayer film, the first release coating layer separating from the multilayer film with the first release liner.

53. A method of applying a multilayer film to a substrate, the multilayer film, comprising
a first transparent film layer having an upper surface and a lower surface;
an ink layer or an ink receptive layer overlying the upper surface of the first transparent film layer;
a second transparent film layer overlying the ink layer or ink receptive layer;
a first release liner overlying the second transparent film layer;
a first release coating layer positioned between the first release liner and the second transparent film layer;
a first adhesive layer overlying the lower surface of the first transparent film layer, the first adhesive layer comprising a pressure sensitive adhesive;
a second release liner overlying the first adhesive layer; and
a second release coating layer positioned between the second release liner and the first adhesive layer;
the method comprising:
separating the second release liner from the multilayer film, the second release coating layer separating from the multilayer film with the second release liner;
placing the multilayer film over the substrate with the first adhesive layer in contact with the substrate and adhering the multilayer film to the substrate; and
separating the first release liner from the multilayer film, the first release coating layer separating from the multilayer film with the first release liner.

54. A method of forming a decal from a multilayer film, the multilayer film comprising:
a first transparent film layer having an upper surface and a lower surface;
a second transparent film layer overlying the upper surface of the first transparent film layer;
an ink layer, ink receptive layer or metalized layer overlying and adhered to a surface of the first transparent film layer or a surface of the second transparent film layer;
a first adhesive layer overlying the lower surface of the first transparent film layer;
a second release liner overlying the first adhesive layer; and
a second release coating layer positioned between the second release liner and the first adhesive layer;
the method comprising:
die cutting the multilayer film down to the surface of the second release coating layer to outline the decal; and
stripping out the waste material surrounding the decal.
